(19) United States
(12) Patent Application Publication
(10) Pub. No.: US 2024/0235191 A1
(43) Pub. Date: Jul. 11, 2024

(54) BUILDING ENERGY SYSTEM WITH BLOCKCHAIN CARBON CREDIT VERIFICATION

(71) Applicant: Johnson Controls Tyco IP Holdings LLP, Milwaukee, WI (US)

(72) Inventors: Dimitrios S. Papadopoulos, Westwood, NJ (US); Sydney Thomas, Larsen, WI (US); Emily Yourich, Caledonia, WI (US); Grace Beauchamp, Mequon, WI (US); Peter Nicholls, Sheffield (GB); Jace White, Wichita, KS (US); Srishti Khurana, New Bremen, OH (US); Jordan Lewandowski, New Berlin, WI (US)

(21) Appl. No.: 18/405,785

(22) Filed: Jan. 5, 2024

Related U.S. Application Data
(60) Provisional application No. 63/437,799, filed on Jan. 9, 2023.

(51) Int. Cl. H02J 3/00; G06Q 50/06

(52) U.S. Cl. CPC H02J 3/003; G06Q 50/06; G06Q 2220/123; H02J 2300/20

(57) ABSTRACT

A method for incentivizing carbon emissions reduction of a building includes generating a carbon offset token based on equipment data. The carbon offset token represents a quantified amount of carbon emissions reduction resulting from a reduced amount of energy consumption or an amount of green energy generation for the building indicated by the equipment data. The method includes validating a new block of a first blockchain. The carbon offset token is an attribute or data of the new block of the first blockchain. The first blockchain is limited from public access. The method includes providing the first blockchain as an input to a new block or a sidechain of a second blockchain. The second blockchain is publicly accessible and includes the carbon offset token as a result of providing the first blockchain as an input to the new block or sidechain of the second blockchain.

### CROSS-REFERENCE TO RELATED PATENT APPLICATION

This application claims the benefit of and priority to U.S. Provisional Application No. 63/437,799, filed Jan. 9, 2023, the entire disclosure of which is incorporated by reference herein.

### BACKGROUND

In device networks, a central server handles device identity confirmation, login requests, facilitates contracts between devices, and various other tasks. In a network such as this, the operation of the devices is often dependent on the central server. In short, the entire network relies on a single entity, the central server, and thus the entire network has a single point of failure. The entire device network can be disrupted by the central server ceasing to function properly. Since the entire network depends on the central server, a breach of the central server can disrupt the entire network by compromising the central server. Further, in instances when the central server crashes, goes offline, or experiences a fault, all of the devices that depend on the central server may cease to properly function even if the devices themselves are not experiencing a fault.

Further, various records or data for the device network can be stored in the central server. Each device of the network can rely on the integrity of the records stored in the central server. If the records stored by the central server become corrupted or compromised, the devices of the device network may unknowingly rely on corrupted or otherwise compromised data. Further, a compromised central server may result in maintenance costs for the central server and may increase required communication overhead because devices must communicate with the central server, rather than with each other.

### SUMMARY

One implementation of the present disclosure is a building automation system (BAS) for a building, according to some embodiments. In some embodiments, the BAS includes multiple devices including processing circuitry. The processing circuitry is configured to obtain time series data indicating reduced energy consumption of building equipment of the building, or green energy generation for the building, according to some embodiments. The processing circuitry is also configured to determine a corresponding carbon emissions reduction resulting from the reduced energy consumption of the building equipment or the green energy generation, according to some embodiments. The processing circuitry is also configured to create a carbon offset token responsive to the corresponding carbon emissions reduction being greater than a threshold, according to some embodiments. The processing circuitry is also configured to validate a new block of a first blockchain, according to some embodiments. In some embodiments, the carbon offset token is an attribute or data of the new block of the first blockchain, the first blockchain being limited from public access. In some embodiments, the processing circuitry is configured to provide the first blockchain as an input to a new block or a sidechain of a second blockchain. In some embodiments, the second blockchain is publicly accessible and includes the carbon offset token as a result of providing the first blockchain as an input to the new block or sidechain of the second blockchain.

In some embodiments, the corresponding carbon emissions reduction is either (i) measured based on data from a metering device and utility data, or (ii) estimated based on equipment data of the building equipment, space data of a space of the building, and a model of the building equipment. In some embodiments, the green energy generation for the building includes any of BioEnergy, GeoThermal energy, solar photovoltaic energy, hydropower energy, ocean energy, or wind energy.

In some embodiments, new blocks of the first blockchain are validated by multiple validators of the building. In some embodiments, the multiple validators are different networked devices of the BAS.

In some embodiments, the new block of the first blockchain are validated using a proof of work or a proof of stake consensus algorithm. In some embodiments, the carbon offset token includes multiple attributes. In some embodiments, the attributes include an indication of an offset type of the corresponding carbon emissions reduction, an indication of the threshold of the corresponding carbon emissions reduction, a date and time that the carbon offset token is created, whether the carbon offset token is created based on meter data or estimated data, one or more addresses of validators of the carbon offset token, and the time series data used to create the carbon offset token. In some embodiments, the carbon offset token is exchangeable on the second blockchain for a tax refund for an owner of the carbon offset token.

Another implementation of the present disclosure is a method for a carbon credit blockchain for a building, according to some embodiments. In some embodiments, the method includes obtaining time series data indicating reduced energy consumption of building equipment of the building or green energy generation for the building. In some embodiments, the method includes determining a corresponding carbon emissions reduction resulting from the reduced energy consumption of the building equipment or the green energy generation. In some embodiments, the method includes creating a carbon offset token responsive to the corresponding carbon emissions reduction being greater than a threshold. In some embodiments, the method includes validating a new block of a first blockchain. In some embodiments, the carbon offset token is an attribute or data of the new block of the first blockchain. In some embodiments, the first blockchain is limited from public access. In some embodiments, the method includes providing the first blockchain as an input to a new block or a sidechain of a second blockchain. In some embodiments, the second blockchain is publicly accessible and includes the carbon offset token as a result of providing the first blockchain as an input to the new block or sidechain of the second blockchain. In some embodiments, the steps of obtaining the time series data, determining the corresponding carbon emissions reduction, creating the carbon offset token, validating the new block, and providing the first blockchain as the input are implemented cooperatively by multiple devices.

In some embodiments, the corresponding carbon emissions reduction is either (i) measured based on data from a metering device and utility data, or (ii) estimated based on equipment data of the building equipment, space data of a space of the building, and a model of the building equipment. In some embodiments, the green energy generation for the building includes any of BioEnergy, GeoThermal energy, solar photovoltaic energy, hydropower energy, ocean energy, or wind energy.

In some embodiments, new blocks of the first blockchain are validated by multiple validators of the building. In some embodiments, the multiple validators are different networked devices of the BAS. In some embodiments, the new block of the first blockchain are validated using a proof of work or a proof of stake consensus algorithm.

In some embodiments, the carbon offset token includes multiple attributes. In some embodiments, the attributes include an indication of an offset type of the corresponding carbon emissions reduction, an indication of the threshold of the corresponding carbon emissions reduction, a date and time that the carbon offset token is created, whether the carbon offset token is created based on meter data or estimated data, one or more addresses of validators of the carbon offset token, and the time series data used to create the carbon offset token. In some embodiments, the carbon offset token is exchangeable on the second blockchain for a tax refund for an owner of the carbon offset token.

Another implementation of the present disclosure is a method for incentivizing carbon emissions reduction of a building, according to some embodiments. In some embodiments, the method includes generating a carbon offset token based on equipment data. In some embodiments, the carbon offset token represents a quantified amount of carbon emissions reduction resulting from a reduced amount of energy consumption or an amount of green energy generation for the building indicated by the equipment data. In some embodiments, the method includes validating a new block of a first blockchain. In some embodiments, the carbon offset token is an attribute or data of the new block of the first blockchain. In some embodiments, the first blockchain is limited from public access. In some embodiments, the method includes providing the first blockchain as an input to a new block or a sidechain of a second blockchain. In some embodiments, the second blockchain is publicly accessible and includes the carbon offset token as a result of providing the first blockchain as an input to the new block or sidechain of the second blockchain.

In some embodiments, the amount of carbon emissions reduction is either (i) measured based on data from a metering device and utility data, or (ii) estimated based on equipment data of the building equipment, space data of a space of the building, and a model of the building equipment. In some embodiments, the green energy generation for the building includes any of BioEnergy, GeoThermal energy, solar photovoltaic energy, hydropower energy, ocean energy, or wind energy.

In some embodiments, new blocks of the first blockchain are validated by validators of the building. In some embodiments, the validators are different networked devices of the BAS.

In some embodiments, the carbon offset token includes multiple attributes. In some embodiments, the attributes include an indication of an offset type of the carbon emissions reduction, an indication of a threshold of the carbon emissions reduction used to generate the carbon offset token, a date and time that the carbon offset token is created, whether the carbon offset token is created based on meter data or estimated data, one or more addresses of validators of the carbon offset token, and the time series data used to create the carbon offset token. In some embodiments, the carbon offset token is exchangeable on the second blockchain for a tax refund for an owner of the carbon offset token.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic drawing of a building equipped with a HVAC system, according to some embodiments.

FIG. 2 is a block diagram of a system of HVAC equipment in the building of FIG. 1 communicating to a cloud platform, according to some embodiments.

FIG. 3 is a system block diagram of the HVAC equipment in the building of FIGS. 1-2 in greater detail, according to some embodiments.

FIG. 4 is a block diagram of an internet enabled HVAC device of the building of FIGS. 1-3 in greater detail, according to some embodiments.

FIG. 5 is a block diagram of a system of HVAC devices communicating via a network, the HVAC devices including an HVAC data chain, according to some embodiments.

FIG. 6 is a block diagram of the system of FIG. 5 shown to include a carbon credits server including the HVAC data chain of FIG. 5, according to an exemplary embodiment.

FIG. 7, is a block diagram of the system of FIG. 5 illustrating one HVAC device receiving carbon credits from another HVAC device based on the HVAC data chain of FIG. 5, according to some embodiments.

FIG. 8, is a block diagram of the system of FIG. 5 illustrating devices coordinating data access between the devices based on the HVAC data chain of FIG. 5, according to some embodiments.

FIG. 9 is a block diagram of one of the HVAC devices of FIG. 5 shown in greater detail, according to some embodiments.

FIG. 10A is a block diagram of a block controller of the HVAC device of FIG. 9 in greater detail, according to some embodiments.

FIG. 10B is a block diagram of components the HVAC device of FIG. 9 that generate a hash solution for a block, according to some embodiments.

FIG. 11 is a block diagram of components of the HVAC device of FIG. 9 that validate and add a solved block to the HVAC data chain of FIG. 5, according to some embodiments.

FIG. 12 is a block diagram for providing the HVAC device of FIG. 9 with carbon credits based on a carbon credit entitlement recorded in the HVAC data chain of FIG. 5, according to some embodiments.

FIG. 13 is a block diagram of components of the HVAC device of FIG. 9 for granting access for HVAC data to another HVAC device of FIG. 5 based on the HVAC data chain of FIG. 5, according to some embodiments.

FIG. 14 is a flow diagram of a process that can be performed by the HVAC devices of FIG. 5 for solving a block and adding the block to the HVAC data chain of FIG. 5, according to some embodiments.

FIG. 15 is a flow diagram of a process that can be performed by the HVAC devices of FIG. 5 for validating a block and adding the validated block to the HVAC data chain of FIG. 5, according to some embodiments.

FIG. 16 is a flow diagram of a process that can be performed by the HVAC devices of FIG. 5 for determining carbon credit entitlements for an HVAC device and sending carbon credits to other HVAC devices, according to some embodiments.

FIG. 17 is a flow diagram of a process that can be performed by the HVAC devices of FIG. 5 for validating a carbon credits request based on the HVAC data chain of FIG. 5, according to some embodiments.

FIG. 18 is a flow diagram of a process that can be performed by the HVAC devices of FIG. 5 for facilitating data access rights between the HVAC devices of FIG. 5, according to some embodiments.

FIG. 19 is a diagram illustrating a system that implements a blockchain that includes carbon offset tokens backed by carbon emissions reductions, according to some embodiments.

FIG. 20 is a diagram illustrating a controller of the system of FIG. 19, according to some embodiments.

FIG. 21 is a diagram illustrating the system of FIG. 19 implemented across various devices, according to some embodiments.

FIG. 22 is a flow diagram of a process for implementing a blockchain having carbon offset tokens that are backed by carbon emissions reductions, according to some embodiments.

FIG. 23 is a diagram illustrating a system that implements Metaverse Building Certifications (MBCs) and establishes non-fungible tokens (NFTs), according to some embodiments.

FIG. 24 is a flow diagram of a process for implementing a MBC NFT, according to some embodiments.

FIG. 25 is a flow diagram of a process for establishing a NFT for building equipment, according to some embodiments.

### DETAILED DESCRIPTION

### Overview

Referring generally to the FIGURES, systems and methods are shown for maintaining and utilizing a distributed HVAC data chain among a plurality of HVAC devices, according to various exemplary embodiments. The plurality of HVAC devices can communicate via a network such as a TCP/IP network. The network may not include any kind of central server and/or may not rely on a central server to operate. Rather, the HVAC devices can each store a copy of an HVAC data chain that includes information that can be distributed among all of the HVAC devices. The HVAC data chain can be any kind of distributed database such as a blockchain database. Rather than relying on a central server for information such as device identity information, transaction information, contract history, and control and supervisory action records, the information can be stored on all of the HVAC devices based on the HVAC data chain. Using blockchain in a building can result in high levels of reliability for the HVAC devices of the building and can provide a much more secure system than a centralized system.

The HVAC data chain can be a chain of multiple blocks. Each block can be linked to a previous block based on a hash value. The hash value of a particular block can rely on the hash of the previous block and the data inside the particular block. Since the blocks are linked in this way, any changes to a block in the chain changes that block's hash which will break the link and thus the blocks will not be properly linked. The blocks can contain information such as transaction and contract history, control action records, supervisory control action records, and other information that needs to be securely stored and/or authenticated. Each of the blocks of the HVAC data chain can include a digital signature that can be used to verify that the block is authentic, that is, the data of the block was created by the device that claims to have created the data. As more blocks are added to the HVAC data chain, it becomes exponentially more difficult to compromise the HVAC data chain. As compared to a centralized system, the difficulty to compromise the centralized system is linear or constant.

The hash values linking blocks together are generated with hash functions. Hash functions are not reversible, that is, one cannot predict the output of a hash function from a given input. A hash solution for a block is generated by repeatedly hashing an adjustable value in the block called a nonce, the hash value of a previous block in the HVAC data chain, and the data to be added to the HVAC data chain. A hash that meets a difficulty criteria is considered a solution to the block and can be added to the HVAC data chain. In some embodiments, the difficulty criteria is that the hash value is less than a predefined amount or more than a predefined amount. An HVAC device using the HVAC data chain can receive requests to add new blocks to the HVAC data chain from services, devices or other entities in the system. The HVAC device can add the block to the HVAC data chain by generating a hash solution. This method may be known as proof of work.

The unpredictable nature of the hash function can make it difficult for a device to find a random input that produces a valid hash of the block. In some cases, depending on the difficulty criterion, it can take trillions of different trials trying different nonce values until a valid hash is found. This can make it difficult to change data in a block of the HVAC data chain. By distributing the blocks on the network, the disadvantage of having a single point of failure can be eliminated and the network can become tolerant to hacking attacks at a single node of the network.

Using blockchain with HVAC devices can result in higher levels of security for a building management system (BMS) since a single point of failure is removed. If a cyber-attack is launched against the BMS, the cyber-attack would need to compromise the HVAC data chain of all the HVAC devices instead of just the data stored on a central server of the BMS. Using the HVAC data chain can result in a high byzantine fault tolerance. Further, there may be mass disintermediation due to consensus-driven decision-making associated with the HVAC data chain. Further, using the HVAC data chain may lower data corruption security breach uncertainties. Using blockchain can allow the HVAC devices to enter permanent and/or time based contracts or transactions among each other without any human intervention. In a building with HVAC devices, the HVAC devices can use blockchain to store and validate energy consumption information, load curtailment information, carbon credits, transmit access rights and licensing information, transmit control actions that can have significant impact on the controlled environment, perform transaction negotiation between two HVAC devices, transport sensitive information across the HVAC device network, and can be used for any communication in building automation and control implementations that have environment requirements that require validation and security. The HVAC data chain can be used for any communication in a BMS (e.g., transport of sensitive information) and/or other control implementation that have validated environment requirements.

### Building With Distributed Edge Devices

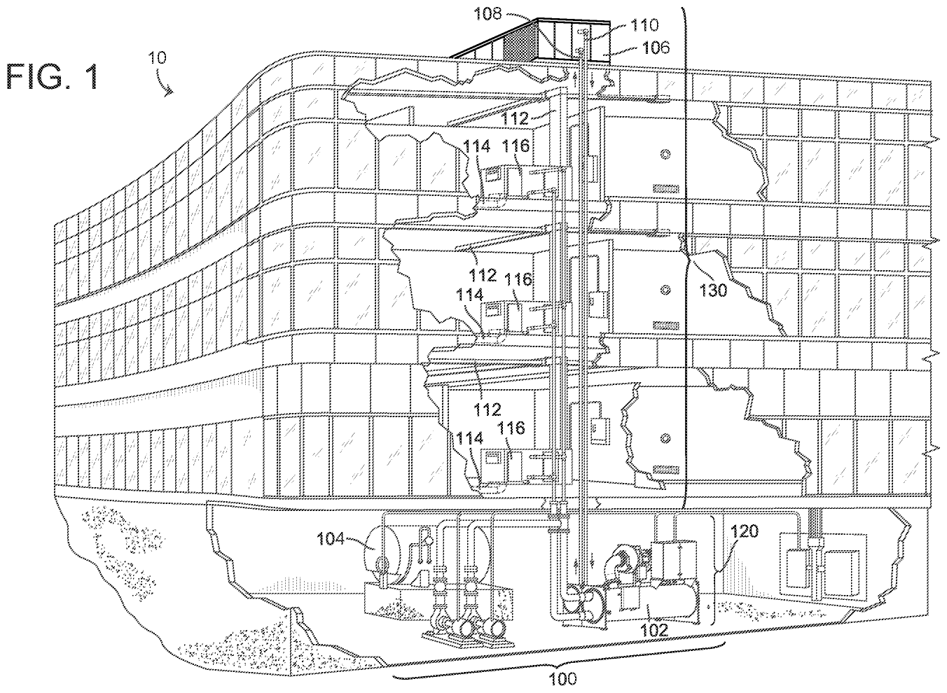

Referring now to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

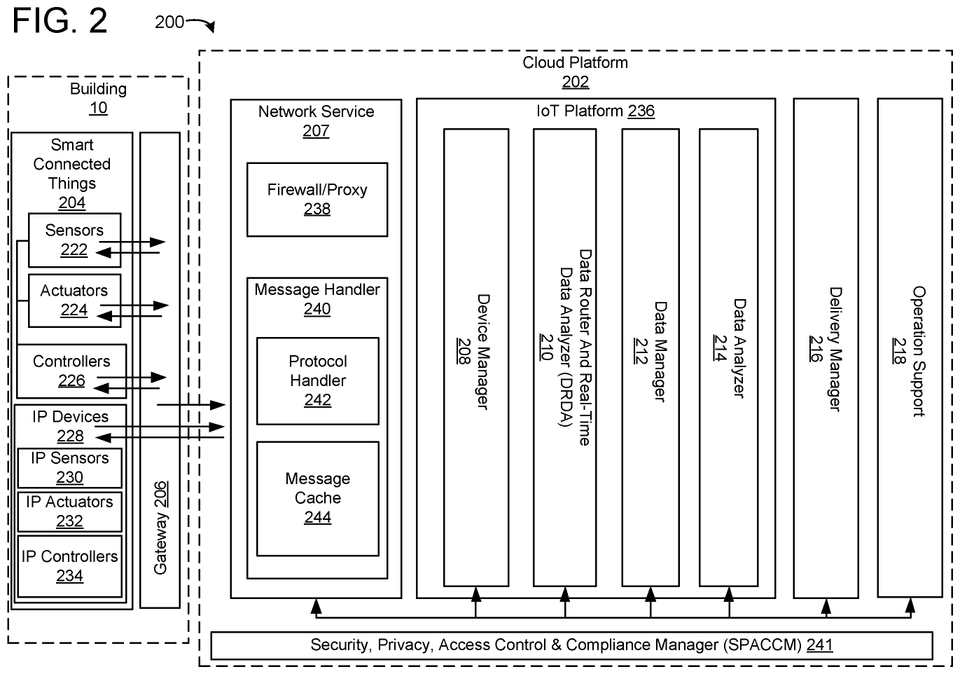

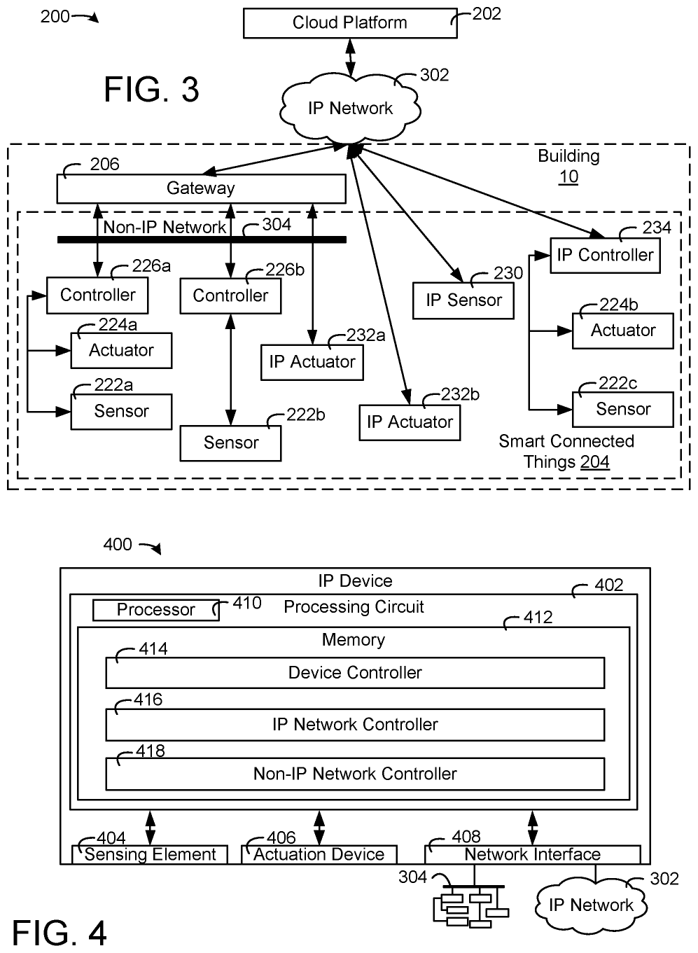

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system and airside system which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

Referring now to FIG. 2, system 200 is shown to include devices of building 10 coupled to a cloud platform 202, according to an exemplary embodiment. Cloud platform 202 can be one or more controllers, servers, and/or any other computing device that can be located in building 10 and/or can be located remotely and/or connected to the systems of building 10 via networks (e.g., the Internet). Cloud platform 202 can be configured to cause building 10 and the devices of building 10 to be a “self-conscious building.” A self-conscious building can be a building in which building devices are interconnected via a cloud, e.g., cloud platform 202. A building of interconnected devices can be “self-conscious” in the regard that rather than having a specific controller make specific decisions for only a portion of the equipment in building 10, cloud platform 202 can receive and aggregate data from all devices of building 10 and thus make decisions for building 10 based on an aggregate set of data.

In FIG. 2, cloud platform 202 includes various services and components in some embodiments. Cloud platform 202 includes network service 207, Internet of Things IoT platform 236, delivery manager 216, and operation support 218, in some embodiments. System 200 is shown to include smart connected things 204. Smart connected things 204 includes sensors 222, actuators 224, controllers 226, and IP devices 228. Smart connected things 204 can include actuators, dampers, chillers, heaters, rooftop units (RTUs), thermostats and air handling units (AHUs), or any other type of equipment or device that can be installed within a building (e.g., fans, pumps, valves, etc.). Sensors 222 can include one or more devices that can be configured to measure various environmental conditions (e.g., light intensity, occupancy, temperature, humidity, air quality, etc.). Actuators 224 can be any device that can be configured to affect an environmental change in building 10 (e.g., maintain a setpoint in building 10, maintain an air quality level in building 10, etc.).

Controllers 226 can be any device that can be connected to sensors 222 and actuators 224. Controllers 226 can be configured to operate actuators 224 and/or collect data from sensors 222. In this regard, controllers 226 can be configured to collect data from sensors 222 and control actuators 224 based on the data received from sensors 222. Sensors 222, actuators 224, and controllers 226 may not be configured to communicate via an IP based network but can be configured to communicate with each other via a non-IP based network. In this regard, sensors 222, actuators 224, and controllers 226 may not be able to communicate directly with cloud platform 202 since the device are not Internet enabled but must communicate with cloud platform 202 via gateway 206. Cloud platform 202 can be configured to communicate via both non-IP based networks and IP based networks.

IP devices 228 can be any device in building 10 that is connected to cloud platform 202 via an IP based network. In this regard, IP devices 228 can include the hardware and/or software necessary to communicate via an IP based network. IP devices 228 can be configured to communicate directly to cloud platform 202 rather than communicating to cloud platform 202 via gateway 206. IP devices 228 are shown to include IP sensors 230, IP actuators 232, and IP controllers 234. IP sensors 230 can be similar to sensors 222. However, IP sensors 230 can communicate directly with cloud platform 202 (e.g., IP sensors 230 can communicate via an IP based network). Further, IP actuators 232 can be similar to actuators 224 and/or IP controllers 234 can be similar to controllers 226. IP actuators 232 and/or IP controllers 234 can be configured to communicate directly to cloud platform 202 via an IP based network instead of communicating to cloud platform 202 via gateway 206.

Although some embodiments in the specification are described primarily with reference to HVAC equipment, it should be understood that the systems and methods described herein can be applicable to a wide variety of building equipment and other types of connected devices (e.g., HVAC equipment, LED lights, lighting systems mobile phones, elevator systems, fire safety systems, security systems, smart street lamps, cars, televisions, etc.) with embedded intelligence and communication capabilities.

Gateway 206 can be any kind of network gateway that can be configured to aggregate and enrich data received from smart connected things 204. Gateway 206 can be used to connect the equipment of smart connected things 204 among each other in addition to connecting smart connected things 204 to cloud platform 202. In this regard, the equipment of smart connected things 204 can be legacy equipment that may not have Internet connectivity, devices that can communicate via a non-IP based network, and/or be new equipment that does have Internet connectivity, equipment that can communicate via an IP based network. Gateway 206 can get, retrieve, query, and/or receive data from smart connected things 204 and/or control smart connected things 204 based on instructions or analytics results received from cloud platform 202.

Gateway 206 can provide network security, access control, and unique address of legacy devices endpoints for remote access and protocol mediation services. In some embodiments, gateway 206 is a general-purpose gateway solution made by any of a variety of hardware manufacturers (e.g., INTEL®, FREESCALE®, DELL®, TEXAS INSTRUMENTS®, etc.). In other embodiments, gateway 206 is a network connection engine (NCE) or a mobile access portal (MAP) gateway used specifically to connect building management systems and smart equipment. Gateway 206 can use various IP based protocols (e.g., Constrained Application Protocol (CoAP), Extensible Message and Presence Protocol (XMPP), Advanced Message Queuing Protocol (AMQP), Message Queue Telemetry Transport (MQTT), etc.) and web based common data exchange (e.g., Hypertext Transfer Protocol (HTTP), Representational State Transfer (RESTful), and Application Programming Interfaces (APIs)) to send data from smart connected things 204 to cloud platform 202.

Network service 207 can provide access to the Internet and/or can include and/or provide access to other types of data networks, such as a local area network (LAN), a wide area network (WAN), a cellular network, a satellite network, a radio network, or any other type of data network or combination thereof. Network service 207 is shown to include a firewall/proxy 238, protocol handlers 242, message handler 240, and message cache 244. Network service 207 can include any number of computing devices (e.g., computers, servers, routers, network switches, etc.) configured to transmit, receive, or relay data. Network service 207 can further include any number of hardwired and/or wireless connections.

Network service 207 can include services that facilitate managing fixed or wireless communication with smart connected HVAC things 204. Network vendors can include, for example, cellular telecommunications providers (e.g., VERIZON®, T-MOBILE©, AT&T®, etc.) as well as Internet service providers. Communications via network service 207 can leverage enterprise contracts and partnerships to optimize the cost of data transmission. Many network carriers provide a secure connection option as a part of premium services. However, a similar degree of network securities can be achieved via employing trust platform chip in smart connected smart connected things 204 and using encrypted messaging such as AMQP via an IP based secure transport.

Firewall/proxy 238 can be any firewall and/or proxy which protects smart connect things 204 from hacking, spyware, malware, or other threats or computer viruses. In this regard, firewall/proxy 238 can allow smart connected things 204 to be connected to cloud platform 202 and/or the Internet while minimizing the risk that smart connected things 204 can be hacked and/or otherwise used by unauthorized persons who can attempt to access smart connected things 204 via the Internet or any other network. Message handler 240 can be configured to facilitate communicate between smart connected things 204 and cloud platform 202. For example, message handler 240 can be configured to send and/or receive data directly from IP devices 228 (e.g., IP sensors 230, IP actuators 232, and/or IP controllers 234). Further, message handler 240 can be configured to send and receive data indirectly from sensors 222, actuators 224, and/or controllers 226 via gateway 206.

Message handler 240 is shown to include protocol handler 242 and message cache 244. In some embodiments, protocol handler 242 can be configured to decode and/or otherwise process the data received from smart connected things 204 based on the network protocol used to transmit the data to cloud platform 202. Further, protocol handler 242 can send messages to smart connected tings 204 based on a particular network protocol. Message cache 244 can be any type of data cache (e.g., hardware and/or software component) that accounts for redundancies in messaging. For example, message cache 244 can be any type of network cache which stores data that is commonly accessed by and/or frequently sent to smart connected things 204. By storing the highly requested and/or highly transmitted data locally in message cache 244, the highly requested data does not need to be repeatedly requested from other various components of cloud platform 202.

System 200 is shown to include, security, privacy, access control, and compliance manager (SPACCM) 241. Security can be provided at both the device (e.g., smart connected things 204) and network levels (e.g., cloud platform 202). The same intelligence that enables devices to perform their tasks can also enable them to recognize and counteract threats. At any given point in time, IoT platform 236 can support multiple users and stake holders including building owners, building operators, tenants, service technicians, manufacturers, and the like. Cloud platform 202 can allow remote accessibility of smart connected things 204 (e.g., via the Internet). For this reason, remote accessibility of connected products can involve complex identity management through a unified login and product management experience that can be facilitated by SPACCM 241. For example, a single login can allow a customer to sign on to all connected products and services associated with IoT platform 236.

Still referring to FIG. 2, cloud platform 202 is shown to include IoT platform 236. IoT platform 236 is shown to include device manager 208, data router and real-time data analyzer 210, data manager 212, and data analyzer 214. IoT platform 236 can include various large IoT solution providers such as MICROSOFT®, INTEL®, CISCO®, GOOGLE®, AMAZON®, SAP®, QUALCOMM®, and/or ORACLE® that offer general-purpose solutions with developer tools for customization in addition to AXEDA®, ETHERIOS®, THINGWORX®, and GENERAL ELECTRIC® (GE®) that offer integrated industry solutions. In some embodiments, IoT platform 236 leverages the industry's first on-premises, off-premises hybrid architecture, MICROSOFT AZURE®.

Device manager 208 can be configured to identify smart connected things 204. In some embodiments, device manager 208 identifies smart connected things 204 via a token sent by smart connected things 204 and/or via any other login credential. For example, the token can be an encrypted key that device manager 208 can decrypt. Based on the identity of a device of smart connected things 204, device manager 208 can allow the device to retrieve data and/or software stored by IoT platform 236. Device manager 208 can be further configured to generate control signals for smart connected things 204 and/or otherwise control the functionality of smart connected things 204.

Data router and real-time data analyzer (DRDA) 210 can be configured to route data in cloud platform 202 and/or to building 10 in addition to performing real-time data analytics. DRDA 210 can be configured to route messages received from smart connected things 204 to various components of cloud platform 202, devices of building 10, and/or other devices connected to the Internet. Further, DRDA 210 can be configured to perform complex event processing. DRDA 210 can be configured to infer (derive) events and/or event patterns based on data received from various data streams. The data streams can be data streams received from building 10, data streams received from cloud platform 202, data streams received from the Internet, and/or any other received data and/or data stream. Complex event processing can identify various events quickly (e.g., in real time). The events can be security threats, emergencies for building 10, and/or other events which cloud platform 202 needs to respond to quickly. For this reason, DRDA 210 can be configured to respond to any event which it determines needs a quick and/or immediate response.

Data manager 212 can include one or more databases, memory storage units, and/or any other hardware and software component that can store and/or manage information. Data manger 212 can include file systems such as Hadoop Distributed File System (HDFS), various databases such as key-value storage, relational database management systems (RDBMS), graph databases, various mapping structures and/or any other system for storing data. In various embodiments, data manager 212 can be configured to manage, organize, integrate, and store data, and/or send data to various components of cloud platform 202. For example, data manager 212 can generate various reports and/combine (e.g., integrate) data from disparate devices in building 10, various components of cloud platform 202, and/or the Internet.

Data analyzer 214 can be configured to perform data processing on data received from smart connected things 204, various components of cloud platform 202, and the Internet. Data analyzer 214 can be configured to perform parallel data analytics on received data and in some embodiments and/or use a software framework such Hadoop to perform the data processing. Data analyzer 214 can be configured to generate business intelligence metrics. Business intelligence metrics can be generated based on the received data. In some embodiments, the business intelligence metrics indicate power consumption of a building, predicted operating costs of new equipment, equipment replacements, and/or any other intelligence metric that can be generated from the received data. Further, data analyzer 214 can be configured to perform data mining to determine various patterns in large data sets that data analyzer 214 can receive and/or collect. Further, data analyzer 214 can be configured to perform any kind of time series data analysis (e.g., data cleansing, data extrapolation, interpolation, averaging). Time series data analysis can be temperatures of a zone collected by a sensors of building 10 e.g., sensors 22. For example, data analyzer 214 can “cleanse” the time series data by compressing the data points based on an upper threshold and/or a lower threshold.

Cloud platform 202 includes delivery manager 216 in some embodiments. Delivery manager 216 is related to channel and distribution strategy and can include a product distributor. A product distributor can include off-line distribution of IoT related products, services and on-line distribution of solutions for a certain customer and/or a market. Delivery manager 216 can include various APIs that enable application developers to deliver information products. Delivery manager 216 can include data visualization, exploration tools, and/or any other method for rapidly delivering data related to building 10 to an end user. In some embodiments, delivery manager 216 is integrated with various enterprise applications e.g., applications owned and/or operated by GOOGLE®, MICROSOFT®, and/or any other entity.

Operation support 218 can facilitate the integration and optimization of devices, systems, and components to unite interrelated applications. Operation support 218 can include various financial and/or customer services. For example, operation support 218 can include various applications for customer relationship management (CRM), enterprise resource planning (ERP), customer billing, reporting information regarding building 10 and/or any other business related application. For example, operation support 218 can facilitate providing data from IoT platform 236 to outside businesses (e.g., insurance companies, utility providers, governmental agencies, etc.) that can have an interest in such data.

Referring now to FIG. 3, smart connected things 204 and building 10 as described with reference to FIGS. 1-2 is shown in greater detail, according to an exemplary embodiment. In FIG. 3, cloud platform 202 as described with further reference to FIG. 2 is shown to be connected to IP network 302. IP network 302 can be any IP network and/or communication protocol. For example, IP network 302 can be and/or include TCP/IP, Ethernet, Wi-Fi, Zigbee IP, a building WAN, etc. Gateway 206, as described with further reference to FIG. 2, is shown to communicate with both IP network 302 and non-IP network 304. Non-IP network 304 can include networks and/or protocols that are not IP based. For example, non-IP network 304 can be and/or include Zigbee, BACnet, controller area network (CAN) protocol, Modbus, and/or any other non-IP based network and/or protocol.

In FIG. 3, controller 226a and 226b are shown to communicate to cloud platform 202 via gateway 206. Controller 226a and 226b can be similar to and/or the same as controllers 226 as described with further reference to FIG. 2. Actuator 224a, sensor 222a, and sensor 222b can be connected to cloud platform 202 via controller 226a and controller 226b respectively. Actuator 224a, sensor 222a, and sensor 222b can be the same and/or similar to actuators 224 and/or sensors 222 as described with further reference to FIG. 2. IP actuator 232a can be connected to cloud platform 202 via gateway 206 even though IP actuator 232a can be able to communicate directly with IP network 302. IP actuator 232a can be the same and/or similar to IP actuator 232 as described with further reference to FIG. 2.

IP sensor 230, IP actuator 232b, and IP controller 234 are shown to communicate directly with cloud platform 202 via IP network 302. IP sensor 230 and IP controller 234 are described with further reference to FIG. 2 while IP actuator 232b can be the same and/or similar to IP actuator 232 as described with reference to FIG. 2. As shown, IP sensor 230, IP actuator 232b, and IP controller 234 communicate to cloud platform 202 without first communicating to gateway 206. IP controller 234 is shown to communicate with actuator 224b and sensor 222c both of which may not be configured to communicate with IP network 302. Actuator 224b and sensor 222c can be the same and/or similar to actuators 224 and sensors 222 as described with further reference to FIG. 2. IP controller 234 can effectively act as a gateway for actuator 224b and sensor 222c and connect both devices to cloud platform 202.

Even though some devices of building 10 must communicate to cloud platform 202 via gateway 206 while other devices can communicate directly with cloud platform 202, the data of all of the devices of building 10 can be “joined together” via cloud platform 202 and/or utilized by cloud platform 202 as an aggregate data set in some embodiments. The devices are “joined together” in the sense that cloud platform 202 can make decisions for all of the devices of building 10 based on all of the data retrieved from all of the devices of building 10. In this regard, building 10 can be understood to be a “self-conscious” building, a building in which decisions are made based on a complete set of data of all building devices.

Referring now to FIG. 4, an IP device 400 is shown, according to an exemplary embodiment. IP device 400 can be any one of IP devices 228 as described with further reference to FIG. 2. IP device 400 is shown to include a network interface 408. Network interface 408 can be a hardware interface which allows IP device 400 to communicate with both non-IP network 304 and IP network 302. IP device 400 is shown to include sensing element 404 and actuation device 406. Sensing element 404 can be one or more hardware components configured to measure temperature, pressure, humidity, pressure, air quality, and/or any other environmental and/or non-environmental condition. Actuation device 406 can be any device that IP device 400 can control to affect an environmental change in building 10. For example, actuator device 406 can be an electric motor that IP device 400 can use to control a valve.

IP device 400 includes a processing circuit 402 that includes processor 410 and memory 412. In this regard, information stored on memory 412 can be executed on processor 410. Memory 412 is shown to include device controller 414. In some embodiments, device controller 414 can send data collected from sensing element 404 to cloud platform 202 via IP network 302. In various embodiments, device controller 414 receives control commands from cloud platform 202 for actuation device 406. In this regard, device controller 414 can be configured to control actuator device 406 based on the commands received from cloud platform 202.

Device controller 414 can be configured to send control commands to various devices connected to IP device 400, receive data from the various devices, receive data from sensing element 404, and/or send commands to actuation device 406. For example, if IP device 400 is IP controller 234 as described with references to FIG. 3, device controller 414 can be configured to control actuator 224b and/or sensor 222c. In this regard, device controller 414 can send data to cloud platform 202 that device controller 414 receives from actuator 224b and/or sensor 222c.

Further, device controller 414 can be configured to send control commands to actuator 224b and/or 222c based on messages and/or data device controller 414 can receive from IP network 302.

IP network controller 416 can be configured to facilitate communicate with IP network 302. In some embodiments, IP network controller 416 includes instructions for various Internet communication protocols (e.g., Transmission Control Protocol/Internet Protocol (TCP/IP), Internet Protocol Version 4 (IPv4), Internet Protocol Version 6 (IPv6), etc.). Non-IP network controller 418 can be configured to facilitate communication with non-IP network 304 and/or any other non-IP based network or communication protocol for communicating with other devices in building 10.

### Distributed HVAC Blockchain Database Systems and Methods

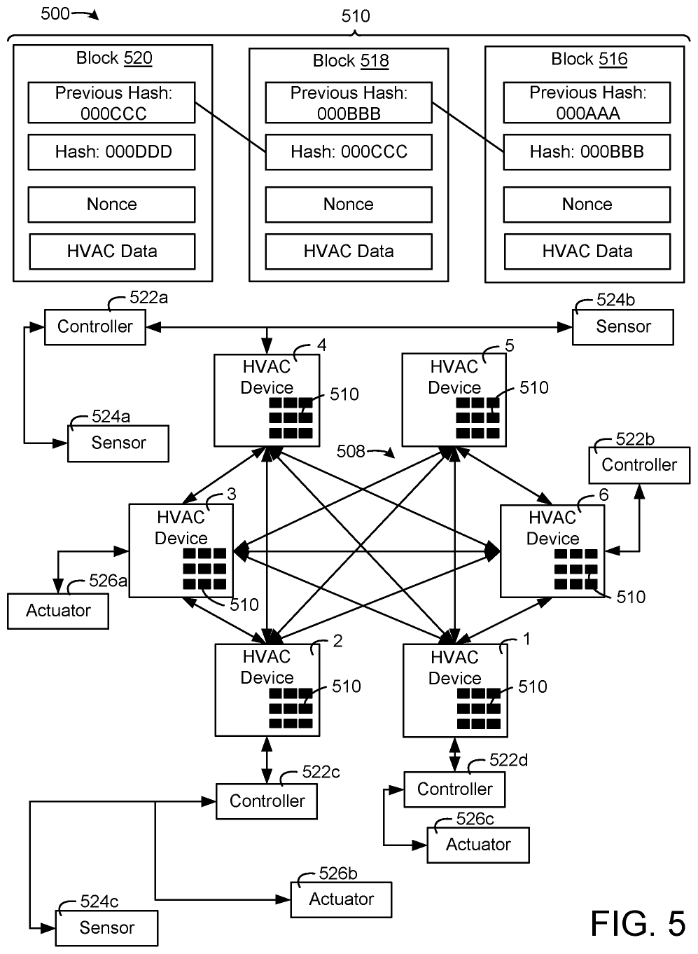

Referring now to FIG. 5, a system 500 of HVAC devices communicating via a network, with the HVAC devices storing an HVAC data chain 510, is shown, according to some embodiments. System 500 is shown to include a number of HVAC devices communicating via a network 508 (e.g., a distributed network). The number of HVAC devices are shown to include HVAC device 1, HVAC device 2, HVAC device 3, HVAC device 4, HVAC device 5, and HVAC device 6. There can be any number of HVAC devices in system 500. HVAC devices 1-6 can be any controller, actuator, or sensor that can communicate via network 508. In some embodiments, HVAC devices 1-6 are building gateways and/or various other building devices or building controllers. HVAC devices 1-6 can be the devices of smart connected things 204 and/or gateway 206 as described with reference to FIGS. 2-3 (e.g., controllers 226a-b, actuators 224, sensors 220, etc.) In some embodiments, HVAC devices 1-6 are VAV boxes of VAV units 116, AHU 106, chiller 102, and/or boiler 104 as described with reference to FIG. 1.

In some embodiments, HVAC devices 1-6 can be computing devices that utilize Software Agents. Software Agents are described with further reference to U.S. patent application Ser. No. 15/367,167 filed Dec. 1, 2016, the entirety of which is incorporated by reference herein.

In some embodiments, HVAC devices 1-6 are located in a single building, multiple buildings, multiple cities, and/or multiple countries. In some embodiments, some and/or all of HVAC devices 1-6 are located in building 10 as described with reference to FIG. 1. HVAC devices 1-6 can be configured to communicate with each other via network 508. Network 508 can be any kind of network such as the Internet, TCP/IP, Ethernet, LAN, WAN, Wi-Fi, Zigbee, BACnet, 5G, LTE, Li-Fi, and/or any combination thereof. HVAC devices 1-6 can communicate via network 508 with various messaging protocols such as Message Queue Telemetry Transport (MQTT), Advanced Message Queuing Protocol (AMQP), ZeroMQ, and can support various publication/subscription and/or push/pull operations.

In some embodiments, some and/or all of HVAC devices 1-6 can be located in a particular building and/or building zone. In some embodiments, each of HVAC devices 1-6 and the devices connected to them are located in a particular zone of building 10. In various embodiments, some and/or all of HVAC devices 1-6 are configured to control the environmental conditions of a particular building and/or building zone. HVAC devices 1-6 are shown to be connected to various sensors, actuators, and controllers. HVAC device 1 is shown to be connected to controller 522d and actuator 526c via controller 522d. HVAC device 2 is shown to be connected to controller 522c and actuator 526b and sensor 524c via controller 522c. HVAC device 3 is shown to be connected to actuator 526a. HVAC device 4 is shown to be connected to controller 522a, sensor 524a, and sensor 524b. HVAC device 6 is shown to be connected to controller 522b. Controllers 522a-d can be the same as or similar to controllers 226 or IP controller 234 as described with further reference to FIG. 2 and/or controllers 226a-b as described with further reference to FIG. 3. Similarly, sensors 524a-c can be the same and/or similar to sensors 222 and/or IP sensors 230 as described with reference to FIG. 2 and/or sensors 222a-c as described with reference to FIG. 3. Further, actuators 526a-c can be similar to and/or the same as actuators 224 and/or IP actuators 232 as described with reference to FIG. 2 and/or actuators 224a-b as described with reference to FIG. 3.

HVAC devices 1-6 can monitor energy consumption, control lighting systems, control HVAC systems, or perform other functions within the BMS. HVAC devices 1-6 can be configured to optimize the systems they control based on energy efficiency, occupants comfort and productivity, and corporate or regulatory policies. HVAC devices 1-6 may be various HVAC devices, building lighting devices, building security devices (e.g., cameras, access control, etc.), safety devices (e.g., devices of a fire system), and/or devices of any other system of a building (e.g., building 10). In some embodiments, using temperature information from a room and/or zone as well as temperature data from an outside sensor, HVAC devices 1-6 can be configured to affect environmental changes in the room and/or zone. In some embodiments, HVAC devices 1-6 can cause dampers (e.g., actuators 526a-c) located in an air duct to be opened or closed, can activate heating, cooling, and/or air circulation equipment in the building and/or zone, and/or can perform any other control command that causes a room, zone, and/or building to be controlled to a particular temperature.

The building that HVAC devices 1-6 are located in may be building 10. Building 10 may include multiple zones and thus, each of HVAC devices 1-6 may be located in a different zone. A zone in building 10 may be a set of rooms and may include equipment installed and/or associated with that particular zone. A zone may be any size and/or may include any number of rooms. There may be devices in a zone connected via a communication bus (e.g., BACnet, Modbus and master slave token passing). Each of the HVAC devices 1-6 may be connected to the communication bus in each and/or some of the zones of the building in addition to network 508. Thus, HVAC devices 1-6 can communicate with other high level controllers (e.g., HVAC devices 1-6), cloud servers or other high level devices, and/or low level devices (e.g., sensors and/or actuators).

HVAC devices 1-6 are shown to each include HVAC data chain 510. HVAC data chain 510 can be a chain of one or more data blocks where each data block is linked to a previous block, thus, forming a chain. The chain may be a chain of sequentially ordered blocks. In some embodiments, HVAC data chain 510 is a blockchain database. HVAC devices 1-6 can exchange building data that they collect via controllers 522a-d, sensors 524a-c, and/or actuators 526a-c via HVAC data chain 510. In some embodiments, HVAC data chain 510 includes information regarding energy consumption, load curtailment, greenhouse gas emissions, carbon credit entitlement or carbon credit balances, or other information that can be used to validate or transact carbon credits for HVAC devices 1-6, access to data for HVAC devices 1-6, and various other building related information. HVAC data chain 510 can be the same on each of HVAC devices 1-6. This allows each device of system 500 to have access to the same information. Further, this allows each of HVAC devices 1-6 to communicate with each other directly rather than relying on a central computing system.

HVAC data chain 510 can include any number of blocks and new blocks can be added to HVAC data chain 510. Three blocks of HVAC data chain 510 are shown in FIG. 5, block 516, block 518, and block 520. Each block is shown to include a nonce, HVAC data, a hash, and a hash of the previous block in the chain. HVAC data chain 510 is illustrated right to left, that is, the rightmost block is the oldest block shown in FIG. 5 while the leftmost block is the newest block shown in FIG. 5. The HVAC data of each block can be contracts, transactions, data (e.g., energy consumption data, carbon credit data, etc.), licenses, access control and/or any other information. In this regard, HVAC devices 1-6 can negotiate contracts amongst each other, as well as establish permissions to information for one or more of HVAC devices 1-6. HVAC data chain 510 can include configuration data of HVAC devices 1-6, and/or any other information. Since HVAC data chain 510 may be public, if one of HVAC devices 1-6 goes offline, any of the other devices can retrieve information for the offline HVAC device from HVAC data chain 510 and take over the responsibilities of the offline HVAC device since any information needed to take over may be public in HVAC data chain 510. In some embodiments, HVAC devices 1-6 can retrieve the information from each other rather than HVAC data chain 510.

Blocks 516-520 are shown to include a nonce value. The nonce value can be a value that when hashed with the HVAC data of the block and the previous hash, in addition to other information, results in a hash that meets a difficulty requirement. In FIG. 5, the difficulty requirement is that the first three values of each hash are zeros. If the hash is considered as a hexadecimal number, the difficulty requirement can be understood as a value that a valid hash must be less than. Any of the HVAC devices 1-6 can attempt to generate a block with a hash value that meets the difficulty requirement. In some embodiments, some and/or all of HVAC devices 1-6 work on generating a hash value for a new block to be added to HVAC data chain 510. If one of the HVAC devices 1-6 generate a hash that meets the difficulty requirement, that HVAC device can add the block to HVAC data chain 510 and notify the other devices of HVAC device 4 of the solved block so that the other HVAC devices can also add the solved block to the HVAC data chain 510 that they store.

In some embodiments, the blocks of HVAC data chain 510 make up a record of data for a building and/or for various devices. For example, the blocks of HVAC data chain 510 may each comprise HVAC data associated with the building. Each block may store HVAC data of a particular device of HVAC devices 1-6. Together, in HVAC data chain 510, the blocks may make up a record of all the HVAC data associated with the building. In another example, the blocks each include information pertaining to energy consumption or carbon credit information for HVAC devices 1-6. On their own, the blocks may only indicate the energy consumption or carbon credit information for one of HVAC devices 1-6. However, together, in HVAC data chain 510, the blocks may represent a record of all energy consumption or carbon credits for a particular building and/or for HVAC devices 1-6. In yet another example, the blocks of HVAC data chain 510 may each individually include information pertaining to a particular zone of a building. HVAC devices 1-6 can be configured to generate and/or retrieve the data and adding them to a block of HVAC data chain 1-6. Individually, the blocks of HVAC data chain 510 may represent HVAC data for only particular zones, however, together, in HVAC data chain 510, the blocks may represent HVAC data for a plurality of zones and/or for a particular building that includes the plurality of zones. This concept of storing a complete record of information in pieces in blocks of HVAC data chain 510 can be used to store any kind of data described herein.

In some embodiments, if HVAC data chain 510 indicates that HVAC device 1 is entitled to X carbon credits as a result of energy reduction or load curtailment activities performed by HVAC device 1, HVAC device 1 can send the X carbon credits to any of HVAC devices 1-6 or via another block chain network since each of HVAC devices 1-6 can verify, via HVAC data chain 510, that HVAC device 1 is entitled to X carbon credits. In some embodiments, HVAC data chain 510 can indicate that HVAC device 1 has a balance of Y carbon credits which includes various amounts of carbon credits earned by HVAC device 1 during corresponding time periods (e.g., X1 carbon credits earned during a first time period, X2 carbon credits earned during a second time period, etc.) as a result of operating HVAC device 1 in a manner that reduces energy consumption or otherwise entitles HVAC device 1 to the carbon credits. The time periods may correspond to blocks of HVAC data chain 510 and the amounts of carbon credits earned during each time period or block may be represented as transactions within the various blocks.

Each block of data chain 510 can include a signature. This signature can be used by each of HVAC devices 1-6 to verify that the data published in HVAC data chain 510 has been published by one of HVAC devices 1-6. This signature can be a digital signature such as an RSA signature or other signature type as described elsewhere herein. Using a digital signature can stop a device from “imitating” another device and allows of HVAC devices 1-6 to confirm the authenticity of a particular block in HVAC device chain 510.

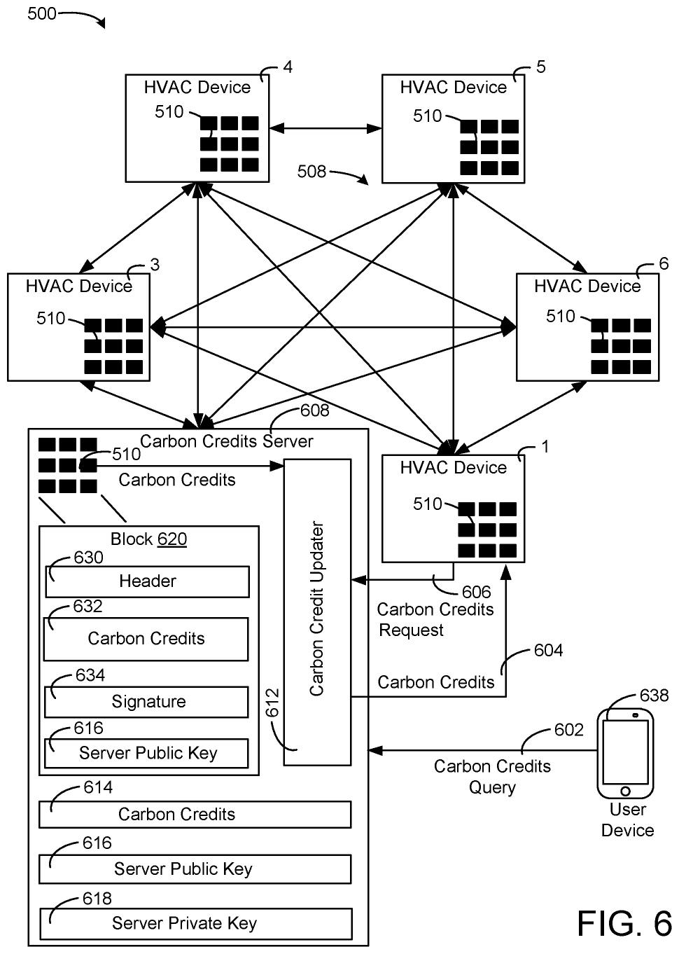

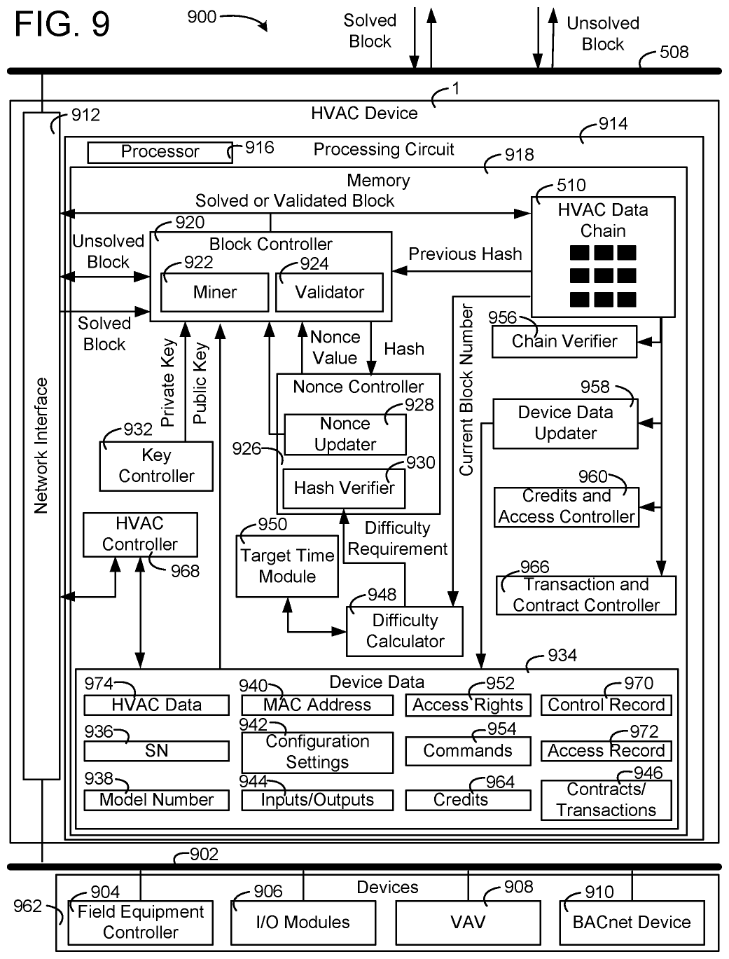

Referring now to FIG. 6, another embodiment of system 500 is shown including a carbon credits server 608, according to some embodiments. Carbon credits server 608 can be any computing device and can be the same and/or similar to HVAC devices 1-6. In various embodiments, carbon credits server 608 includes a processing circuit with a processor and a memory device, the processing circuit being configured to perform some and/or all of the functionality of carbon credits server 608. The processing circuit, the processor, and the memory of carbon credits server 608 can be the same and/or similar to processing circuit 914, processor 916, and memory 918 as described with further reference to FIG. 9. Carbon credits server 608 can be similar to and/or the same as cloud platform 202 as described with further reference to FIG. 2.

In FIG. 6, system 500 is shown to include user device 638. User device 638 can be any laptop computer, desktop computer, smart phone, tablet, and/or any other computing device that a user can use to interact with carbon credits server 608 and/or HVAC devices 1-6. In this regard, user device 638 may communicate with carbon credits server 608 via the Internet (e.g., network 508). Carbon credits server 608 is shown to receive a carbon credits query 602 from user device 638. Carbon credits query 602 can be a message indicating that a user wants to know how many carbon credits have been earned for a particular HVAC device, such as HVAC device 1. In some embodiments, the HVAC devices 1-6 monitor a building system that earns a carbon credit. The HVAC devices 1-6 may monitor and control the building system that earns the carbon credit, and can identify that the building system is meeting appropriate criteria to earn a carbon credit.

Carbon credits server 608 is shown to include carbon credit updater 612 which can be configured to communicate with HVAC devices 1 and 3-6 (carbon credits server 608 may take the place of HVAC device 2 in this embodiment). Carbon credit updater 612 can be configured to receive carbon credit requests and distribute carbon credits to HVAC devices 1 and 3-6 upon validating HVAC devices 1 and 3-6 have earned the requested carbon credits as a result of energy reduction or other sustainability-related activities performed by HVAC devices 1 and 3-6. Further, carbon credit updater 612 can facilitate interactions with user device 638. In some embodiments, carbon credit updater 612 can generate a block for HVAC data chain 510 that includes carbon credit information.

In response to validating that HVAC device 1 has earned a given number of carbon credits, carbon credits server 608 (the functionality of which may be implemented in a decentralized manner across all the HVAC devices) can be configured to generate block 620 that includes a corresponding amount of carbon credits for HVAC device 1. In some embodiments, all of the HVAC devices operate in a decentralized manner to generate block 620 or to perform any of the functionality of the carbon credits server 608. Block 620 can include a block header 630, carbon credits 632 for HVAC device 1, a signature 634, and a server public key 636. Carbon credits server 608 is shown to include server public key 616 and server private key 618. Carbon credits server 608 can generate server public key 616 and/or server private key 618. Server public key 616 and/or server private key 618 can be a Rivest, Shamir, and Adelman (RSA) key pair in addition to any other key pair type for digitally signing data, some of which are referred to herein. The signature 634 can be used to verify, by HVAC devices 1 and 3-6, that carbon credits 632 are authentic, that is, it has been generated by an authorized entity, carbon credits server 608.

Carbon credits server 608 can send block 620 to other devices in system 500, HVAC devices 1 and 3-6, so that HVAC devices 1 and 3-6 can determine a solution for block 620 and add the block to HVAC data chain 510. In some embodiments, HVAC devices 1 and 3-6 can use signature 634, server public key 616, and carbon credits 632 to verify that block 620 originated from carbon credits server 608.

HVAC device 1 can be configured to determine that HVAC device 1 is entitled to the requested amount of carbon credits based on HVAC data chain 510. HVAC device 1 can verify that block 620 includes a signature 634 for carbon credits server 608. Further, HVAC device 1 can be configured to determine that HVAC device 1 is entitled to the requested amount of carbon credits based on carbon credits 632. In some embodiments, the carbon credit balance of each of HVAC devices 1-6 is stored in HVAC data chain 510 and thus adding a new block 620 to HVAC data chain 510 updates the carbon credit balance of one or more of HVAC devices 1-6 in the distributed ledger formed by HVAC data chain 510.

In other embodiments, in response to determining, based on HVAC data chain 510, that HVAC device 1 is entitled to a given number of carbon credits, HVAC device 1 can send carbon credits request 606 to carbon credits server 608. Carbon credits request 606 can be a request for the carbon credits allocated to HVAC device 1 in block 620, shown as carbon credits 632 in FIG. 6. Carbon credits server 608 can be configured to determine, based on HVAC data chain 510 that HVAC device 1 is entitled to the number of carbon credits being requested in carbon credits request 606. In response to determining that HVAC device 1 is entitled to the requested carbon credits, carbon credits server 608 can be configured to send HVAC device 1 carbon credits 604. Carbon credits 604 can be a particular amount of carbon credits that carbon credits server 608 stores in a carbon credits repository or treasury (e.g., an on-chain or off-chain repository or treasury), carbon credits 614, and that carbon credits 632 indicates that HVAC device 1 is licensed for. In some embodiments, any of the information or data that is used to determine or create the carbon credit is stored on-chain or off-chain.

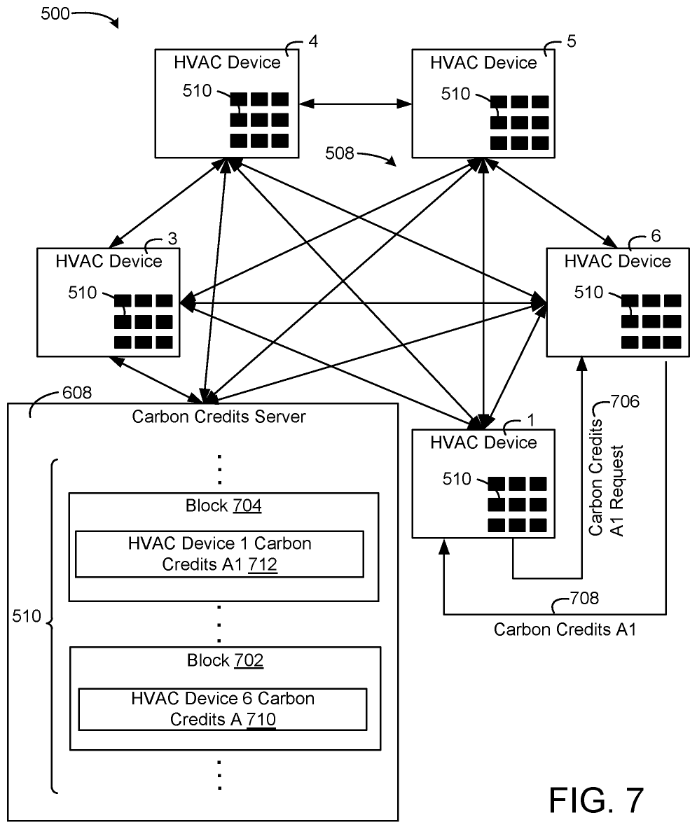

Referring now to FIG. 7, another embodiment of system 500 is shown for transferring carbon credits to one HVAC device from another HVAC device, according to an exemplary embodiment. This may occur, for example, when carbon credits server 608 allocates an amount of carbon credits earned by a HVAC subsystem or group of HVAC devices (e.g., carbon credits A) to one HVAC device in the group (e.g., HVAC device 6) and that HVAC device distributes portions of the carbon credits earned by each individual HVAC device (e.g., carbon credits A1, carbon credits A2, etc.) to the other HVAC devices in the group (e.g., HVAC device 1). In FIG. 7, HVAC device 1 can be configured to send carbon credits A1 request 706 to HVAC device 6. HVAC device 6 is shown to be configured to reply to carbon credits A1 request 706 by sending carbon credits A1 708 to HVAC device 1. In some embodiments, transferring carbon credits A1 708 from HVAC device 1 to HVAC device 6 includes generating a carbon credits transaction and adding the carbon credits transaction to a block of HVAC data chain 510.

HVAC data chain 510 is shown to include block 704 and block 702. Block 702 is shown to include carbon credits A 710 indicating that HVAC device 6 has been allocated carbon credits A. Block 704 is shown to include carbon credits A1 712 indicating that HVAC device 1 has been allocated carbon credits A1. In some embodiments, block 704 is a transaction transferring carbon credits A1 from HVAC device 6 to HVAC device 1. Based on carbon credits 710 and 712 of blocks 702 and 704 of HVAC data chain 510, HVAC device 1 can be configured to determine that it is entitled to a portion of the carbon credits A allocated to HVAC device 6. Blocks 704 and/or 702 may be digitally signed by carbon credits server 608 via server public key 616. HVAC device 1 and/or 6 can determine that the carbon credits 712 and/or 710 are authentic based on the signature and public key 616.

In response to determining that HVAC device 1 is entitled to carbon credits A1 and that HVAC device 6 has carbon credits A including the portion Al of carbon credits to which HVAC device 1 is entitled, HVAC device 1 can be configured to send carbon credits A1 request 706 to HVAC device 6. HVAC device 6, in response to receiving carbon credits A1 request 706, can be configured to use HVAC data chain 510 to determine that HVAC device 1 is entitled to carbon credits A1. In some embodiments, HVAC device 6 determines, based on carbon credits 712 of block 704 of HVAC data chain 510, that HVAC device 1 is entitled to carbon credits A1. In response to determining that HVAC device 1 is entitled to carbon credits A1 based on HVAC data chain 510 and/or in response to receiving carbon credits A1 request 706 from HVAC device 1, HVAC device 6 can be configured to send carbon credits A1 708 to HVAC device 1. In other embodiments, it may be unnecessary to transfer carbon credits between HVAC devices 1-6 in addition to recording the carbon credit transactions in HVAC data chain 510 because HVAC data chain 510 serves as a distributed ledger for such information.

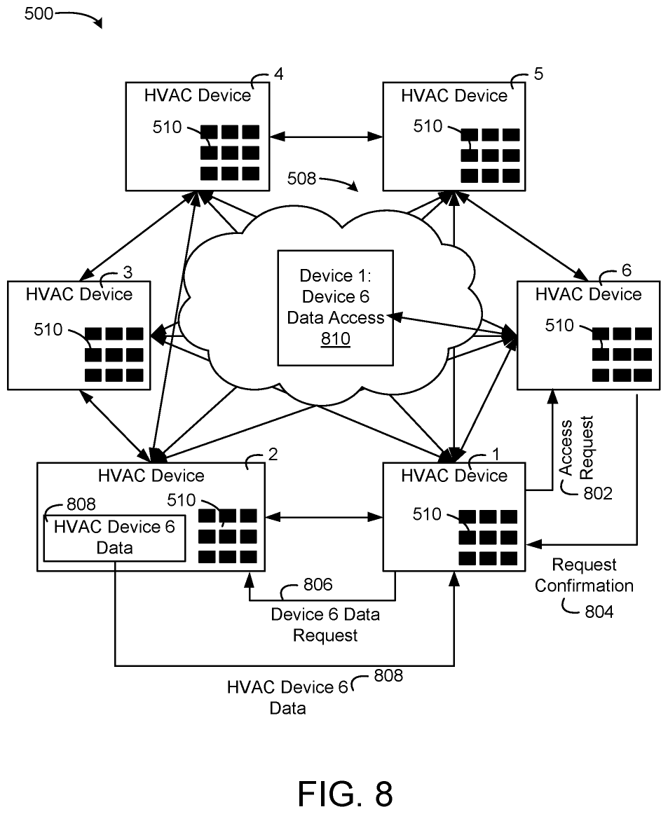

Referring now to FIG. 8, system 500 is shown in which two devices coordinate data access between the two devices, according to an exemplary embodiment. It is contemplated that HVAC data chain can store any type of information and is not limited to carbon credits. For example, in FIG. 8, HVAC device 1 is shown to be configured to send an access request 802 to HVAC device 6. Access request 802 can be a request for specific HVAC data of HVAC device 6, such as HVAC device 6 data 808. In some embodiments, HVAC device 6 data 808 can be data for a particular zone such as zone temperature, zone humidity, zone air quality, etc. In some embodiments, HVAC device 6 collects HVAC device 6 data via various sensors, actuators, and/or controllers.

In response to receiving access request 802, HVAC device 6 can be configured to send request confirmation 804 to HVAC device 1. Request confirmation 804 can indicate that request confirmation 804 accepted or denied. In response to determining that HVAC device 1 should be authorized to receive HVAC device 6 data, HVAC device 6 can generate a new block, block 810, for HVAC data chain 510. HVAC device 6 can send block 810 to HVAC devices 1-5 so that block 810 can be solved and added to HVAC data chain 510. Block 810 can indicate that HVAC device 6 has given HVAC device 1 access to HVAC data of HVAC device 6.

HVAC device 1 can be configured to determine, based on HVAC data chain 510, that HVAC device 2 is authorized to receive HVAC data of HVAC device 6, HVAC device 6 data 808. This can indicate that HVAC device 2 may have the data which HVAC device 1 wants. In response to determining that HVAC device 2 is authorized to receive HVAC device 6 data 808, HVAC device 1 can be configured to send a request to HVAC device 2 for HVAC device 6 data.

In FIG. 8, HVAC device 1 is shown to send HVAC device 6 data request 806 message to HVAC device 2 for HVAC device 6 data 808. HVAC device 1 can determine that HVAC device 2 has HVAC device 6 data 808 by sending a message to HVAC device 2. HVAC device 2 can reply to this message. In some embodiments, HVAC device 2 replies to the message by determining that HVAC device 2 has access to HVAC device 6 data 808 based on HVAC data chain 510. HVAC device 2 can receive device 6 data request 806 from HVAC device 1. Based on HVAC data chain 510, HVAC device 2 can determine that HVAC device 1 is authorized to receive HVAC device 6 data 808. In response to determining that HVAC device 1 is authorized to receive HVAC device 6 data 808, HVAC device 2 can send HVAC device 6 data 808 to HVAC device 1.

In other examples, rather, than using HVAC data chain 510 to determine that HVAC device 2 is also authorized for HVAC device 6 data 808, HVAC device 1 can send device 6 data request 806 to HVAC device 6 and receive HVAC device 6 data 808 from HVAC device 6.

Referring now to FIG. 9, a block diagram illustrating system 900 showing HVAC device 1 in greater detail is shown, according to some embodiments. In system 900, HVAC device 1 is shown to communicate via network 508 as described with further reference to FIG. 5. In this regard, HVAC device 1 can communicate with HVAC devices 2-6 as described with further reference to FIG. 5 and/or with the carbon credits server 608. HVAC device 1 can send a block to be added to HVAC data chain 510 to HVAC devices 2-6 via network 508. Further, HVAC device 1 can be configured to receive a solved block from network 508. A solved block can be a block that includes a solution that one of HVAC devices 2-6 have determined.

HVAC device 1 is shown to communicate via network 902. Network 902 can be a Zigbee, BACnet, controller area network (CAN) protocol, Modbus, and/or any type of field bus. In some embodiments, network 902 is similar to and/or the same as non-TP network 304, IP network 302, and/or network 508. HVAC device 1 is shown to communicate with devices 962. Devices 962 may include field equipment controller 904, I/O modules 906, VAV 908, and BACnet device 910 via network 902. Devices 962 can be any device that can affect an environmental change in a building. Devices 962 can monitor/control VAV units 116, AHU 106, chiller 102, and/or boiler 104 as described with reference to FIG. 1. HVAC device 1 can be configured to receive data (e.g., environmental data for a zone, a building, etc.) from devices 962 and/or send commands to devices 962. In some embodiments, the commands sent from HVAC device 1 to devices 962 can cause devices 962 to affect an environmental change in a building (e.g., building 10) and/or a zone (e.g., a zone of building 10).

HVAC device 1 is shown to communicate via network 508 and network 902 via network interface 912. Network interface 912 can be configured to communicate with network 508 and/or network 902. Network interface 912 can be one or more circuits configured to allow HVAC device 1 to communicate with network 508 and/or network 902. Network interface 912 can be configured to communicate via LANs, metropolitan area networks (MANs), and WANs. Network interface 912 can be configured to communicate via the Internet, Ethernet, Wi-Fi, a field bus, MODBUS, BACnet, CAN, near field communication (NFC), Zigbee, Bluetooth, and/or any other network and/or combination thereof. Network interface 912 can include one or more wired and/or wireless transceivers and/or receives (e.g., a Wi-Fi transceiver, a Bluetooth transceiver, a NFC transceiver, a cellular transceiver, etc.).

In some embodiments, network interface 912 includes one or more processing circuits and/or memory devices. In some embodiments, network interface 912 is wholly and/or partially part of processing circuit 914. In this regard, network interface 912 and/or processing circuit 914 can include computer instructions necessary for communicating with network 508 and/or network 902.

Processing circuit 914 is shown to include a processor 916 and memory 918. Processor 916 can be a general purpose or specific purpose processor, an application specific integrated circuit (ASIC), one or more field programmable gate arrays (FPGAs), a group of processing components, or other suitable processing components. Processor 916 can be configured to execute computer code and/or instructions stored in memory 918 or received from other computer readable media (e.g., CDROM, network storage, a remote server, etc.).

Memory 918 can include one or more devices (e.g., memory units, memory devices, storage devices, etc.) for storing data and/or computer code for completing and/or facilitating the various processes described in the present disclosure. Memory 918 can include random access memory (RAM), read-only memory (ROM), hard drive storage, temporary storage, non-volatile memory, flash memory, optical memory, or any other suitable memory for storing software objects and/or computer instructions. Memory 918 can include database components, object code components, script components, or any other type of information structure for supporting the various activities and information structures described in the present disclosure. Memory 918 can be communicably connected to processor 916 via processing circuit 914 and can include computer code for executing (e.g., by processor 916) one or more processes described herein.

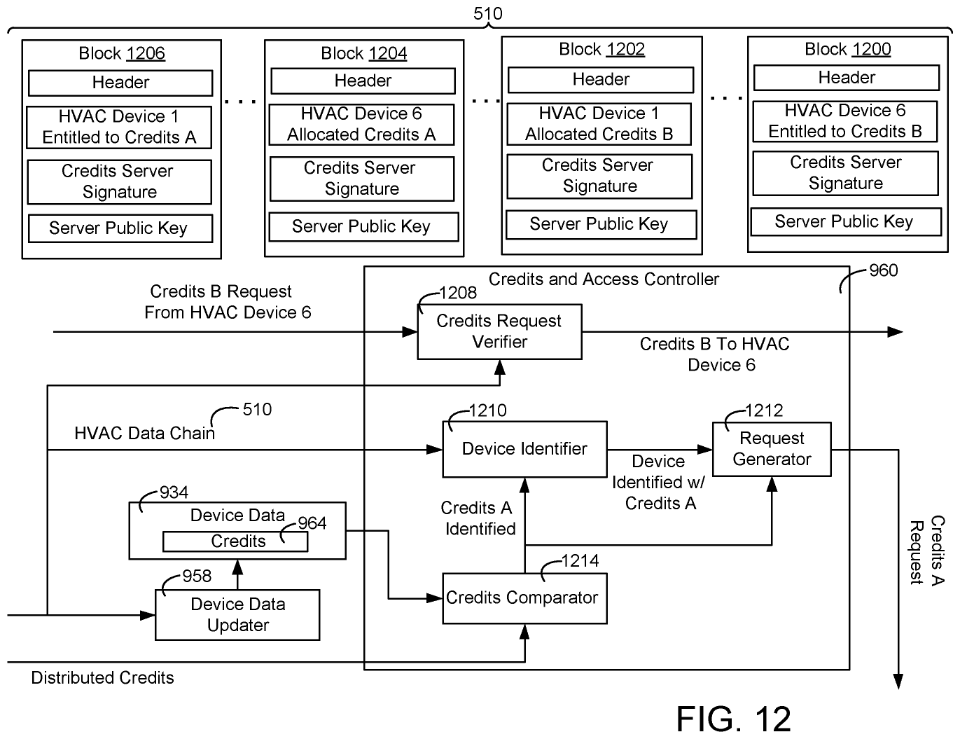

Memory 918 is shown to include various components for operating HVAC device 1. These various components can be executed on processor 916. Memory 918 is shown to include block controller 920, HVAC data chain 510 as described with reference to FIG. 5, key controller 932, nonce controller 926, chain verifier 956, device data updater 958, credits and access controller 960, difficulty calculator 948, target time module 950, device data 934, and/or transaction and contract controller 966. Credits and access controller 960 can be configured to facilitate carbon credits transactions for HVAC device 1 and data access from other HVAC devices. Credits and access controller 960 is described with further reference to FIG. 12.

Block controller 920 can be configured to generate blocks for HVAC data chain 510 and send the blocks to HVAC devices 2-6 via network 508. HVAC devices 2-6 can be configured to solve the block which block controller 920 sends them. Also, block controller 920 can be configured to attempt to solve the blocks that it generates and/or sends to HVAC devices 2-6. Block controller 920 can be configured to receive solved blocks from network 508 (e.g., HVAC devices 2-6). Block controller 920 can be configured to validate the block and then add the validated block to HVAC data chain 510. Block controller 920 is shown to include miner 922 and validator 924. Miner 922 can be configured to generate a solution for a block that block controller 920 generates and/or a block that block controller 920 receives from network 508 and/or HVAC devices 2-6. Validator 924 can be configured to receive a solved block from network 508 and/or HVAC devices 2-6. Validator 924 can be configured to verify that the block has been solved and can be configured to add the solved block to HVAC data chain 510.

Nonce controller 926 can be configured to generate a nonce value to be used by block controller 920 in solving a block. Block controller 920 can be configured to hash the nonce value with other data of the block it is trying to solve. Nonce controller 926 is shown to receive a hash from block controller 920. The hash can be the result of the nonce value hashed with the data of the block. Hash verifier 930 of nonce controller 926 can be configured to determine if the hash received from block controller 920 meets a difficulty requirement. In response to determining that the difficulty requirement has been met, hash verifier 930 may notify block controller 920 that the block has been solved and may notify block controller 920 of the nonce value that solved the block. In response to determining that the hash has not met the difficulty requirement, hash verifier 930 can cause nonce updater 928 to update the nonce value provided to block controller 920. Nonce updater 988 can update the nonce value it provides to block controller 920. Nonce updater 988 can increment and/or decrement the nonce value to be hashed by block controller 920. In some embodiments, nonce updater 928 can pseudo-randomly generate a new nonce value to be hashed with block controller 920.

Difficulty calculator 948 can be configured to determine a difficulty requirement and provide the difficulty requirement to nonce controller 926. In some embodiments, the difficulty requirement is a requirement that the hash value has a certain property or meets a certain criteria. For example, a possible difficulty requirement can be that a hash value generated by block controller 920 has zero as the first four characters of the hash. For example, a hash “ab893ab00c3” may not meet the difficulty requirement and thus may not be a solution to a particular block. However, the hash “0000aa92bbb” may meet the difficulty requirement of the block and be a valid solution for the block. Difficulty calculator 948 can be configured to increase the difficulty and/or decrease the difficulty to meet a target time. For example, difficulty calculator 948 can increase the number of zeros that must be at the beginning of a hash to be a valid solution for a block while difficulty calculator 948 can also decrease the number of zeros that must be at the beginning of a hash to be a valid solution for a block. In some embodiments, the difficulty requirement is that the hash is less than a particular number. In this regard, difficulty calculator 948 can be configured to raise or lower the particular number to increase or decrease the difficulty.

Difficulty calculator 948 can adjust the difficulty level to maintain a predefined target solution time. The solution time can be a desired time for when one of HVAC devices 1-6 publishes a block to all of HVAC devices 1-6 and one of HVAC devices 1-6 generate a hash that meets the current difficulty requirement. The average time it takes for one of the HVAC devices 1-6 to determine a solution to a block can be known as a block time. The block time can be dependent on the amount of “hashing power” (e.g., computing power) in system 500. For example, the number of devices in system 500 that are attempting to solve a hash can change over time, thus the total computing power of system 500 can change over time. To adjust to these changes, difficulty calculator 948 can be configured to adjust the difficulty to maintain a particular target time.

In some embodiments, difficulty calculator 948 receives a target time from target time module 950. In some embodiments, the target time is the amount of time for HVAC devices 1-6 to add a predefined number of blocks to HVAC data chain 510. Every predefined number of blocks, difficulty calculator 948 can be configured to determine the amount of time it took to add the predefined amount of blocks. Based on the target time, difficulty calculator 948 can be configured to raise and/or lower the difficulty.

Difficulty calculator 948 can use timers, the current block number, and/or other information to adjust the difficulty requirement. In some embodiments, all of HVAC devices 1-6 are configured to simultaneously update a difficulty requirement on each of HVAC devices 1-6 based on a commonly known target time, a commonly determined average block time, and/or a current block number. In some embodiments, the block number can be used to periodically adjust the difficulty requirement. For example, difficulty calculator 948 can adjust the difficulty requirement every 1000 blocks and/or any other predefined number.

Difficulty calculator 948 can receive a target time from target time module 950. Target time module 950 can store a particular target time. In some embodiments, the target time stored by target time module 950 is specific for the type of system 500. In some embodiments, the target time is the amount of time for HVAC devices 1-6 to add a predefined number of blocks to HVAC data chain 510. The amount of time for HVAC devices 1-6 to add a single block to HVAC data chain 510 is called the block time. Various block times and target times can be ideal for various embodiments of system 500. If system 500 is a group of controllers that monitor/control the temperature of various zones, a lower block time and target time (e.g., a lower than a predefined amount) can be ideal because the devices can need to communicate data quickly. For example, if a user requests a temperature change, the change may be affected quickly by the controllers using a lower block time and target time.

In some examples, the block time and target time for building security devices may be longer in order to make it more difficult for HVAC data chain 510 to be compromised. The block and target time for building security devices can be longer than a predefined amount (e.g., 5 minutes, 10 minutes, 20 minutes, etc.) For example, the block and target time for building security devices may be longer than the block time and target time for devices that affect an environmental change in a building. In contrast, building lighting devices may have a very quick block and target time that is shorter than a predefined amount. If system 500 connects building lighting devices and/or systems together, the block time and target time can need to be very short (e.g., a block time on the order of seconds or milliseconds).

Chain verifier 956 can be configured to verify HVAC data chain 510. Chain verifier 956 can be configured to verify each and every block of HVAC data chain 510 to verify that HVAC data chain 510 has not been compromised and/or corrupted. In some embodiments, chain verifier 956 can be configured to verify the entire HVAC data chain 510 periodically. In some embodiments, chain verifier 956 verifies HVAC data chain 510 when HVAC device 1 is booted up, when HVAC device 1 downloads and/or installs HVAC data chain 510 from one of HVAC devices 2-6, and/or when HVAC device 1 is first connected to network 508. Chain verifier 956 can be similar to validator 924. However, chain verifier 956 may not simply validate a single block, chain verifier 956 can verifier every block of HVAC data chain 510. For example, chain verifier 956 may start by verifying the first block of the HVAC data chain 510 based on signatures and/or hash solutions for the block. Chain verifier 956 can continue to verify each block from the most recent block to the first block, thus, validating the entire HVAC data chain 510.

Device data updater 958 can be configured to update device data 934 based on information stored in HVAC data chain 510. For example, blocks in HVAC data chain 510 can include a plurality of blocks, some of which can indicate that HVAC device 1 has access rights to data on one of HVAC devices 2-6. This can be stored by device data updater 958 in device data 934, access rights 952. Similarly, device data updater 958 can be configured to identify carbon credit transactions in HVAC data chain 510 and update device data 934 with carbon credit information, credits 964. Further, device data updater 958 can be configured to receive various commands from HVAC data chain 510. These commands can be a particular command to control one of devices 962. In some embodiments, the commands are building-wide commands, that is, they may affect all or a large portion of HVAC devices 1-6 as well as a large portion of the zones of building 10. In some embodiments, the commands can include turning off and/or cycling power of all devices at a particular time. In some embodiments, the commands may operate devices of the entire building to heat or cool the building.

Memory 918 is shown to include device data 934. Device data 934 may include information about HVAC device 1, various data retrieved from devices 962, various access information, carbon credit information, and/or any other information. Controller data is shown to include serial number (SN) 936. SN 936 can be a serial code that uniquely identifies HVAC device 1. Device data 934 can also include model number 938. Model number 938 can be a particular model number which identifies the type of HVAC device 1. Media access control (MAC) address 940 can be the MAC address of HVAC device 1, configuration settings 942 can be information which causes HVAC device 1 to operate in a particular manner. For example, configuration settings 942 can indicate that HVAC device 1 retrieves data from devices 962 at a particular interval, that HVAC device 1 operates HVAC devices 962 to maintain a particular environmental setpoint (e.g., temperature, humidity, air quality, etc.) in building 10 and/or a zone of building 10.

Inputs/outputs 944 can represent the inputs and/or outputs of HVAC device 1 and/or devices 962. Inputs/outputs 944 can be binary inputs and/or binary outputs. In some embodiments, inputs/outputs 944 are analog inputs, analog outputs, digital inputs, and/or digital outputs. Any other attribute can be stored in device data 934. The other attributes can be a particular data point calculated from inputs/outputs 944. For example, inputs/outputs 944 can indicate that HVAC device 1 has measured a particular resistance value associated with a thermocouple of one of devices 962. The other attributes can indicate the resistance value, an equation used to convert the temperature value into a temperature, and/or the temperature associated with the resistance value. However, other data types such as valve position (e.g., analog voltage, step value, etc.), fan speed (e.g., an RPM value), compressor speed (e.g., an RPM value) and other data types may be associated with, retrieved from, and/or sent to devices 962.

Device data 934 can include commands 954. Commands 954 can be any command that HVAC device 1 is performing and/or will perform. For example, commands 954 can be a command received from one of HVAC devices 2-6. In some embodiments, command 954 is a command received via HVAC data chain 510. Control record 970 can be a record of some and/or all of the control actions performed by HVAC device 1. In some embodiments, control actions can only be significant actions. Control record 970 can be added to a block in HVAC data chain 510 so that other devices, HVAC devices 2-6 can view control record 970 of HVAC device 1. Access record 972 can be a record of all of the data access and/or control access that HVAC device 1 can have. In some embodiments, access record 972 can indicate what data access HVAC device 1 has from another device of HVAC devices 2-6 and/or has had in the past. Access record 972 can also indicate what control actions HVAC device 1 has access to send to HVAC devices 2-6. Access record 972 can be added to HVAC data chain 510 so that HVAC devices 2-6 can view what access HVAC device 1 has and/or has had in the past.

HVAC controller 968 can be configured to receive environmental data from devices 962 and control field devices 962 to affect an environmental change in a zone and/or building (e.g., building 10). HVAC controller 968 can be configured to use configuration settings 942 to determine appropriate environmental setpoints (e.g., temperature setpoints, humidity setpoints, environmental setpoints) for devices 962 to use in providing environmental control of a space (e.g., a zone). Further, HVAC controller 968 can send data of field devices 962 to inputs/outputs 944 and/or otherwise device data 934.

Device data 934 is shown to include HVAC data 974. HVAC data 974 can be stored by memory 918 and can include environmental information regarding a building (e.g., building 10) and/or a zone of a building (e.g., building 10). In some embodiments, HVAC data 974 includes environmental data associated with HVAC device 1 and/or field devices 962. HVAC data 974 can include information such as temperature trends, humidity trends, average temperature, average humidity, and/or any other HVAC related information. In some embodiments, HVAC data 974 can be energy usage of HVAC device 1 and/or field devices 962. Block controller 920 can add a block to HVAC data chain 510 that includes some and/or all of the data stored in device data 934 including HVAC data 974. Since HVAC data 974 can be HVAC data related to a particular zone and/or HVAC device 1, one block of HVAC data chain 510 can include HVAC data related to HVAC device 1 and/or a particular zone. In some embodiments, all of HVAC devices 1-6 store a block relating to HVAC data pertaining to each of devices 1-6 and/or the zones that HVAC devices 1-6 are located in. For this reason, HVAC data chain 510 can store a record, based on all and/or some of the blocks of HVAC data chain 510, of HVAC data for a plurality of zones, a plurality of devices, and/or an entire building (e.g., building 10).

In some embodiments, HVAC controller 968 provides a control signal to field devices 962 via network interface 912 and/or network 902. The control signal can cause the field devices 962 to condition and/or heat a zone and/or building to a setpoint temperature. Further, the control signals can cause field devices 962 to achieve a humidity value in a building and/or zone based on a humidity setpoint. HVAC controller 968 can use any of a variety of control algorithms (e.g., state-based algorithms, extremum-seeking control algorithms, PID control algorithms, model predictive control algorithms, feedback control algorithms, machine learning algorithms, etc.) to determine appropriate control actions for field devices 962 as a function of temperature and/or humidity.

Transaction and contract controller 966 can be configured to negotiate a transaction and/or contract between HVAC device 1 and one of HVAC devices 2-6. In some embodiments, the transaction and/or contract is a time limited transaction and/or contract, that is, the transaction and/or contract lasts for a predefined amount of time. In various embodiments, a contract can be an exchange of HVAC data, utilizing processing resources of one of the devices entering the contract, generating control commands for another device in the contract, etc. The transactions can be agreements to exchange data, information, and/or services. In some embodiments, the transaction is trading information and/or services between two devices. For example, HVAC device 1 can agree to send HVAC data from HVAC device 1 to HVAC device 2 if HVAC device 2 determines an appropriate energy saving environmental setpoint from the HVAC data and sends the setpoint to HVAC device 1. Any contract and/or transaction can be stored in device data 934 as contracts/transactions 946 and/or can be generated as a block for HVAC data chain 510.

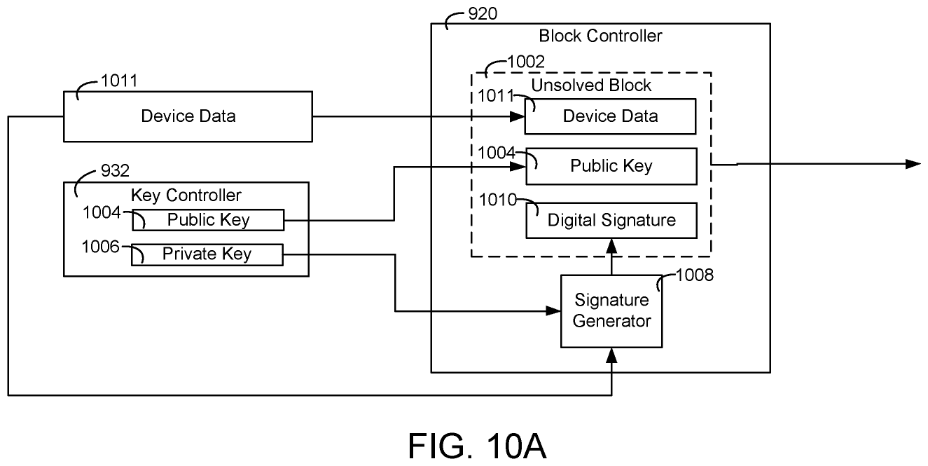

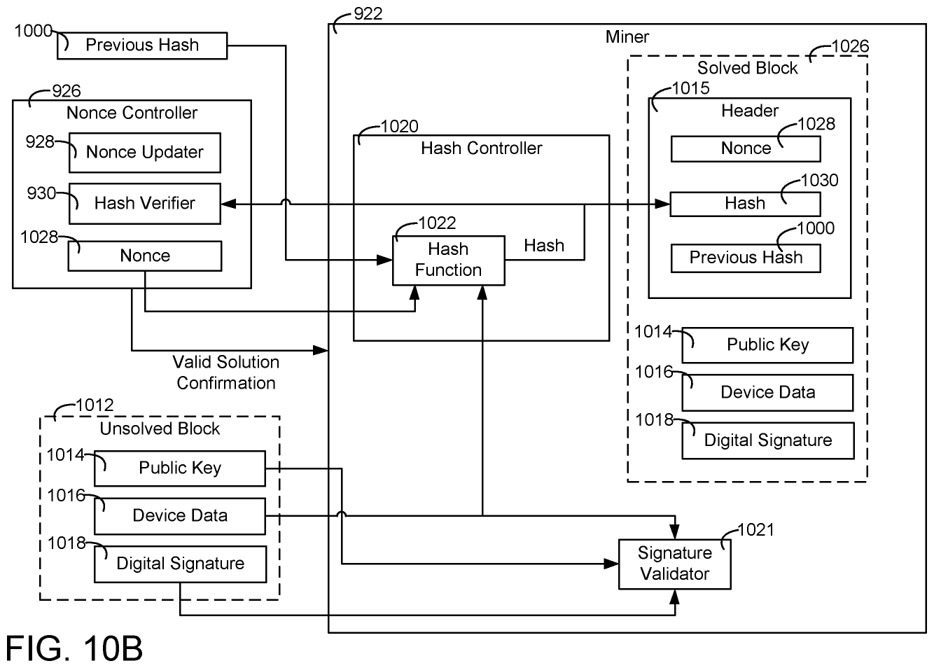

Referring now to FIG. 10A, block controller 920 of FIG. 9 is shown in greater detail, according to an exemplary embodiment. Block controller 920 is shown to receive device data 1011. Device data 1011 can include various transactions, contracts, carbon credits, access, and/or any other information. In some embodiments, device data 1011 is the same and/or similar to device data 934 as described with reference to FIG. 9. For example, device data 1011 can include some, all, or none of the information stored in device data 934 as described with reference to FIG. 9. Block controller 920 is also shown to receive public key 1004 and private key 1006. Public key 1004 and private key 1006 can be generated by key controller 932. Key controller 932 can be configured to generate public key 1004 and private key 1006 via various key generation techniques. In some embodiments, public key 1004 and private key 1006 are keys in a RSA, a digital signature algorithm (DSA), an elliptic curve digital signature algorithm (ECDSA), and/or any signature algorithm and/or combination thereof.

Block controller 920 can generate an unsolved block 1002 and send the unsolved block 1002 to HVAC devices 2-6 of FIG. 5 so that one of HVAC devices 2-6 can generate a solution for unsolved block 1002. Block controller 920 is shown to include signature generator 1008. Signature generator 1008 is shown to receive private key 1006 and device data 1011. In some embodiments, signature generator 1008 generates digital signature 1010 based on private key 1006 and device data 1011. In various embodiments, signature generator 1008 generates a hash value of device data 1011 and/or a hash value of each element of device data 1011 (e.g., generate a merkleroot) and signs the generated hash value with the private key 1006. In some embodiments, signature generator 1008 signs the generated hash with a public key of a particular HVAC device of HVAC devices 2-6. This may be used for a transaction. For example, in a transaction, the second party may be identified in the signature generated by the first party since their public key is used when signing the transaction.

Block controller 920 is configured to include digital signature 1010 and public key 1004 in unsolved block 1002. One of HVAC devices 2-6 that receives unsolved block 1002 can validate the authenticity of unsolved block 1002, that is, determine that unsolved block 1002 was generated by the owner of private key 1006 (i.e., HVAC device 1) by using public key 1004, device data 1011, and digital signature 1010. In some embodiments, digital signature 1010 verifies that device data 1011 is correct. For example, if device data 1011 includes access for a particular device to access device data of HVAC device 1, a transaction, or a contract, etc., other devices can verify that device data 1011 is authentic.

Referring now to FIG. 10B, miner 922 of FIG. 9 is shown in greater detail, according to some embodiments. Miner 922 is shown to include hash controller 1020 that is shown to generate solved block 1026 from unsolved block 1012. Unsolved block 1012 can be an unsolved block generated by one of HVAC devices 1-6. For example, HVAC device 1 can generate unsolved block 1012 and then attempt to solve unsolved block 1012. Further, HVAC device 1 can receive unsolved block 1012 from one of HVAC devices 2-6 and/or carbon credits server 608 via network 508. Generating an unsolved block 1012 is described in FIG. 10A.

Miner 922 is shown to include signature validator 1021 that is configured to verify the authenticity of unsolved block 1012 and/or the contents of unsolved block 1012 (e.g., device data 1016) with algorithms such as RSA, DSA, ECDSA, and/or any other algorithm. Signature validator 1021 is shown to receive public key 1014, device data 1016, and digital signature 1018 of unsolved block 1012. Signature validator 1021 can be configured to generate a Boolean value indicating that unsolved block 1012 is authentic or is not authentic. In some embodiments, when the block includes a transaction, signature validator 1021 may validate the transaction with the public key of both parties in the transaction. In this regard, the signature may be a digitally signed version of the transaction that is signed with the private key and the public key of the first device performing the transaction, and the public key of the second device performing the transaction. In this regard, the transaction can be confirmed with the public keys of both parties. In response to determining that unsolved block 1012 is not authentic, miner 922 can be configured to not generate solved block 1026. In response to determining that unsolved block 1012 is authentic, miner 922 can be configured to generate and/or continue to generate solved block 1026. Signature validator 1021 can be configured to cause public key 1014, digital signature 1018, and/or device data 1016 to be included in solved block 1026.

Hash controller 1020 can be configured to generate hash 1030. Hash controller 1020 can repeatedly generate hash 1030 until hash 1030 meets a particular difficulty requirement. Hash controller 1020 is shown to include hash function 1022. Hash function 1022 can be configured to perform hashing for SHA-256, Scrypt Blake-256, CryptoNight, HEFTY1, Quart, SHA-3, SCRYP-JANE, SCRYPT-N, and/or any other hashing algorithm. In some embodiments, hash 1030 and/or previous hash 1000 are 32 byte numbers. Hash function 1022 can be configured to hash previous hash 1000, nonce 1028 and device data 1016 to generate hash 1030. Previous hash 1000 can be the previous hash solution to the most recent block added to HVAC data chain 510. By using previous hash 1000, a link can be created between solved block 1026 and the most recently added block of HVAC data chain 510.

Nonce controller 926 can adjust (e.g., increment) nonce 1028. Each time nonce 1028 is adjusted, hash controller 1020 can generate a new hash with nonce 1028. Each time hash function 1022 generates a hash, hash verifier 930 can check the generated hash 1030 to determine if hash 1030 meets a difficulty requirement as defined by difficulty calculator 948. If the hash meets the difficulty requirement, nonce controller 926 notifies miner 922 of the nonce which meets the difficulty requirement. Miner 922 can include nonce 1028 that generates the solution in header 1015. The hash meeting the difficulty requirement, hash 1030 can also be included in header 1015.

Miner 922 can be configured to include various information in header 1015. In some embodiments, all of the information in header 1015 is hashed by hash controller 1020 when generating hash 1030. In some embodiments, header 1015 includes a block number, a current time, the current difficulty, etc. This information can be hashed along with previous hash 1000, and/or device data 1016 when generating hash 1030. Header 1015 can further include previous hash 1000 of the newest (e.g., the most recently added) block in HVAC data chain 510.

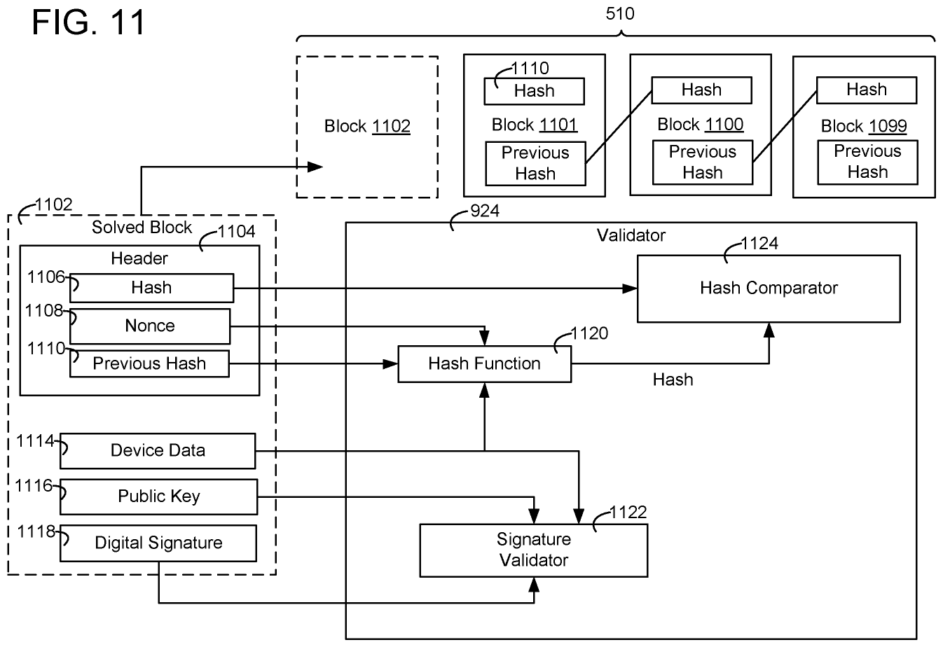

Referring now to FIG. 11, validator 924 of HVAC device 1 of FIG. 9 is shown in greater detail, according to an exemplary embodiment. Validator 924 is shown to validate a solved block 1102 and add solved block 1102 to HVAC data chain 510. Solved block 1102 can be a block that one of HVAC devices 1-6 has generated a solution for, and has sent to the devices of system 500 to be added to the HVAC data chains (e.g., HVAC data chain 510) stored on each of HVAC devices 1-6. Solving a block is described with further reference to FIG. 10B. Solved block 1102 is shown to include header 1104, device data 1114, public key 1116, and digital signature 1118. Header 1104 can be similar to header 1015 as described with reference to FIG. 10B. Header 1104 is shown to include hash 1106, nonce 1108, and previous hash 1110. Hash 1106 can be similar to hash 1030. Hash 1106 can be the result of hashing nonce 1108, previous hash 1110, and device data 1114. Hash 1106 may be a value that meets a difficulty requirement. Previous hash 1110 can be the hash of the previous (e.g., newest) block of HVAC data chain 510. In this example, previous hash 1110 can be the hash of block 1101, hash 1126. Hash function 1120 may be the same as and/or similar to, hash function 1022 as described with reference to FIG. 10B.

Hash function 1120 can be configured to generate a hash value from nonce 1108, previous hash 1110, and device data 1114. The hash can be provided to hash comparator 1124. Hash comparator 1124 can be configured to compare the hash value generated by hash function 1120 to hash 1106. In response to determining that the hash of hash function 1120 matches hash 1106, hash comparator 1124 can be configured to add solved block 1102 to HVAC data chain 510.

Referring now to FIG. 12, credits and access controller 960 is shown in greater detail, according to an exemplary embodiment. Credits and access controller 960 is shown to include device identifier 1210, request generator 1212, credits comparator 1214 and credits request verifier 1208.

FIG. 12 is shown to include device data updater 958 as described with reference to FIG. 9. Device data updater 958 receives HVAC data chain 510 and updates device data 934 based on the HVAC data chain 510. In some embodiments, device data updater 958 identifies that HVAC data chain 510 indicates that HVAC device 1 has earned a particular amount of carbon credits. For example, carbon credits server 608 can have generated a block that was added to HVAC data chain 510 that indicates that HVAC device 1 has earned carbon credits A. In this regard, device data updater 958 can update credits 964 which can store a record of all of the carbon credits of HVAC device 1 (e.g., as a single balance according to an account balance model or as a set of carbon credit transactions using an unspent transaction output (UTXO) model).

For embodiments in which the carbon credit data stored in HVAC data chain 510 indicates entitlement to carbon credits and the actual carbon credits are stored separately on each HVAC device, credits comparator 1214 can be configured to compare the credits 964 of device data 934 with the actual amount of carbon credits on HVAC device 1. In response to determining that HVAC device 1 is entitled to more carbon credits than the amount stored on HVAC device 1, credits comparator 1214 can send an identification of an amount of carbon credits that HVAC device 1 is entitled to have but does not currently have to device identifier 1210. Alternatively, for embodiments in which the carbon credit data stored in HVAC data chain 510 indicates the actual amount of carbon credits allocated to each HVAC device and HVAC devices 1-6 do not store separate amounts of carbon credits apart from HVAC data chain 510, it may be unnecessary to request or transfer carbon credits apart from simply updating HVAC data chain 510 to record the updated amount of carbon credits for each HVAC device 1-6 in the distributed ledger. It is contemplated that either or both of these approaches can be used in practice. In some embodiments, loss of carbon credits is determined due to reversing or changing a setting of any HVAC devices 1-6 or the systems that the HVAC devices 1-6 control to reverse energy saving operations (e.g., transitioning from operating in an energy efficient manner to operating in a less efficient manner).

Device identifier 1210 can be configured to determine, based on the amount of carbon credits identified by credits comparator 1214 and HVAC data chain 510, which of HVAC devices 2-6 might have the carbon credits identified by credits comparator 1214. For example, as described with reference to FIG. 7, some of the carbon credits to which HVAC device 1 is entitled may have been distributed by carbon credits server 608 to a different HVAC device (e.g., HVAC device 6) to reduce the number of transactions from carbon credits server 608. Based on the identified devices, request generator 1212 can be configured to send a carbon credits request to the identified device. An HVAC device that may have the carbon credits may be a device that has received the carbon credits by carbon credits server 608. In this regard, device identifier 1210 can be configured to determine, based on HVAC data chain 510, the HVAC devices to which carbon credits server 608 has distributed the carbon credits.

Credits and access controller 960 is shown to include credits request verifier 1208. Credits request verifier 1208 can be configured to receive a credits request from one of the other HVAC devices 2-6 for a particular amount of carbon credits. Credits request verifier 1208 can be configured to determine that the device requesting the particular amount of carbon credits has earned the carbon credits, based on HVAC data chain 510. Further, credits request verifier 1208 can be configured to determine whether HVAC device 1 stores and/or has received the requested credits (e.g., has been allocated the credits via a transaction in HVAC data chain 510). In response to determining that the requesting device is entitled to the requested credits and/or in response to determining that HVAC device 1 has the requested credits, credits request verifier 1208 can be configured to send the requested credits to the requesting device.

As an example, HVAC data chain 510 indicates at block 1204 that HVAC device 6 has been allocated credits A. Further, block 1206 indicates that HVAC device 1 is entitled to credits A. Both blocks 1204 and 1206 are signed by carbon credits server 608 and include the licensing public key of carbon credits server 608. This confirms that carbon credits server 608 created the blocks and HVAC devices 1-6 can rely on the data stored in blocks 1204 and 1206. In this regard, device data updater 958 can be configured to update credits 964 based on block 1204 indicating that HVAC device 6 has been allocated credits A. Further, device identifier 1210, based on block 1206, can be configured to determine that HVAC device 1 is entitled to credits A. For this reason, request generator 1212 of HVAC device 1 can be configured to send a request for credits A to HVAC device 6.

Both device data updater 958 and credits request verifier 1208 can be configured to verify, based on a server signature of each block, the credits of each block, and a server public key, that each of blocks 1200-1206 were generated by carbon credits server 608. Verifying that the credits originate from carbon credits server 608 can verify that a given HVAC device has actually earned the requested amount of carbon credits and that the request is not improper.

In another example, HVAC data chain 510 indicates at block 1200 that HVAC device 6 is entitled to carbon credits B. HVAC device 6 can determine that it is entitled to credits B based on block 1200. HVAC device 6 can identify another HVAC device, HVAC device 1, that has been allocated credits B based on HVAC data chain 510. Specifically, HVAC device 6 can be configured to identify HVAC device 1 based on block 1202 in HVAC data chain 510. In response to determining that HVAC device 6 is entitled to credits B (based on block 1200) and that HVAC device 1 has credits B (based on block 1202), HVAC device 6 can be configured to send a request to HVAC device 1 for credits B. In response to receiving a request for credits B from HVAC device 6, HVAC device 1 can be configured to determine that HVAC device 6 is entitled to credits B based on HVAC data chain 510, specifically, block 1200. In response to determining that HVAC device 6 is entitled to credits B, HVAC device 1 can be configured to send the requested credits, credits B, to HVAC device 6. Alternatively, it may be unnecessary to send credits between devices apart from simply updating the distributed ledger stored in HVAC data chain 510 as noted above.

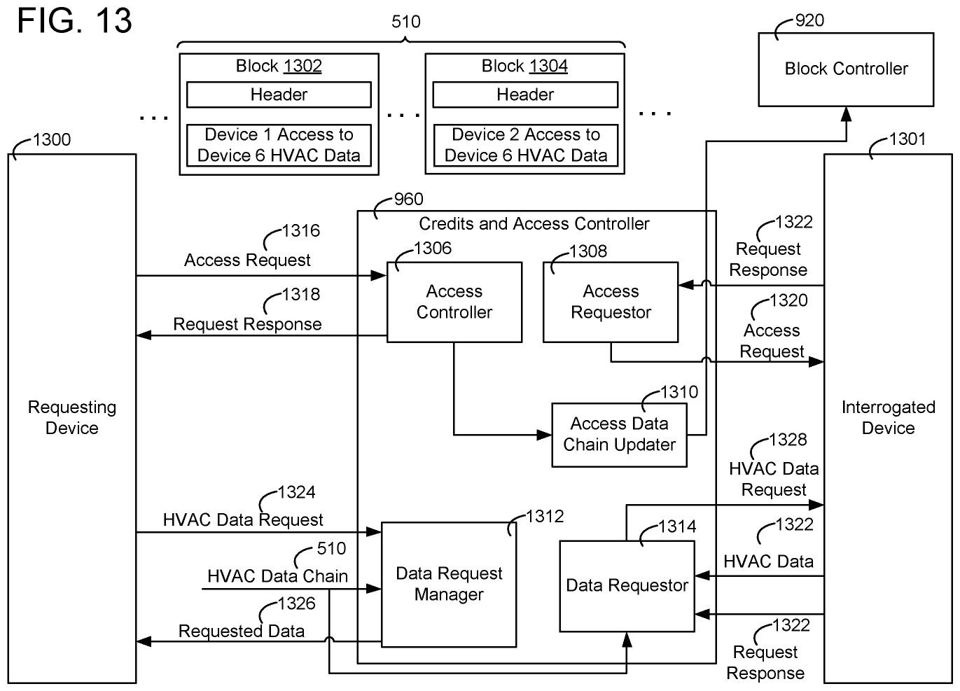

Referring now to FIG. 13, credits and access controller 960 of HVAC device 1 is shown in greater detail, according to an exemplary embodiment. Credits and access controller 960 is shown to include access controller 1306, access requestor 1308, access data chain updater 1310, data request manager 1312, and data requestor 1314. Credits and access controller 960 is shown to communicate with block controller 920 and to receive various messages and information including HVAC data chain 510. FIG. 13 is shown to include a requesting device 1300 and an interrogated device 1301. Requesting device 1300 and interrogated device 1301 can be any device described herein such as HVAC devices 1-6. Requesting device 1300 can be a device requesting access to data of HVAC device 1 while interrogated device 1301 can be a device that HVAC device 1 is requesting access to data from. In some embodiments, requesting device 1300 and interrogated device 1301 are the same device.

In FIG. 13, access controller 1306 is shown to be configured to receive access request 1316 from requesting device 1300. The data being requested can be information such as zone and/or building temperatures, zone and/or building humidity, zone and/or building air quality, zone and/or building schedules, control of various HVAC devices that can be connected and/or controlled by HVAC device 1, and/or any other HVAC information that HVAC device 1 can store.

Access controller 1306 can determine whether to grant and/or deny access request 1316. In some embodiments, access controller 1306 can determine to grant access request 1316 based on permission settings of HVAC device 1. In some embodiments, access controller 1306 may notify a user via an email message, a text message, or a user interface of HVAC device 1 that an HVAC device has sent an access request 1316. The user can review the access request 1316 and prompt access controller 1306 to either accept and/or deny access request 1316. In response to accepting and/or denying access request 1316, access controller 1306 can be configured to send request response 1318 to the device which originally sent access request 1316. Request response 1318 can indicate that the request has been accepted and/or denied.

In response to accepting access request 1316, access data chain updater 1310 can be configured to cause block controller 920 to generate a new block to be solved and added to HVAC data chain 510. The new block can indicate that the device that sent access request 1316 is granted access to certain data and/or other information. The new block may indicate a time period for this access. For example, block 1302 of HVAC data chain 510 indicates that HVAC device 1 has access to certain HVAC data of HVAC device 6. Block 1304 of HVAC data chain 510 indicates that HVAC device 2 has access to HVAC data of HVAC device 6. Generating a new block, using a digital signature to sign the contents of the block, and solving the block, validating the block, and authenticating the device that generated the contents of the block are described with further reference to FIGS. 10A-10B, and elsewhere herein.

Data request manager 1312 can be configured to receive HVAC data request 1324 from requesting device 1300 and/or one of HVAC devices 2-6 other than requesting device 1300. HVAC data request 1324 can be a request for all data of HVAC device 1 and/or specific data of HVAC device 1. Data request manager 1312 can be configured to determine, based on HVAC data chain 510, whether requesting device 1300 has been granted access to the data requested in HVAC data request 1324. In some embodiments, one or more blocks of HVAC data chain 510 indicate that requesting device 1300 has access to the data requested in HVAC data request 1324. In response to determining that requesting device 1300 has been granted access to the data requested in HVAC data request 1324, data request manager 1312 can be configured to send the requested data 1326 to requesting device 1300.

Access requestor 1308 is shown to be configured to send access request 1320 to interrogated device 1301. Interrogated device 1301 can be configured to send request response 1322 indicating whether the access request 1320 has been accepted and/or denied. Request response 1322 can be the same and/or similar to access request 1316.

Data requestor 1314 can be configured to send a data request to one of HVAC devices 2-6 and/or interrogated device 1301. In some embodiments, data requestor 1314 can be configured to determine which of HVAC devices 2-6 have been granted access to the data requested by HVAC device 1 in access request 1320. Determining that one of HVAC devices 2-6 has access to the data can indicate that there is a high probability that that one device has the data. Data requestor 1314 can be configured to send HVAC data request 1328 to interrogated device 1301 and/or any other device of HVAC devices 2-6 that have been granted access to the data. Interrogated device 1301 and/or one of the other devices of HVAC devices 2-6 that data requestor 1314 determines may have the data can be configured to reply to HVAC data request 1328 with HVAC data 1330.

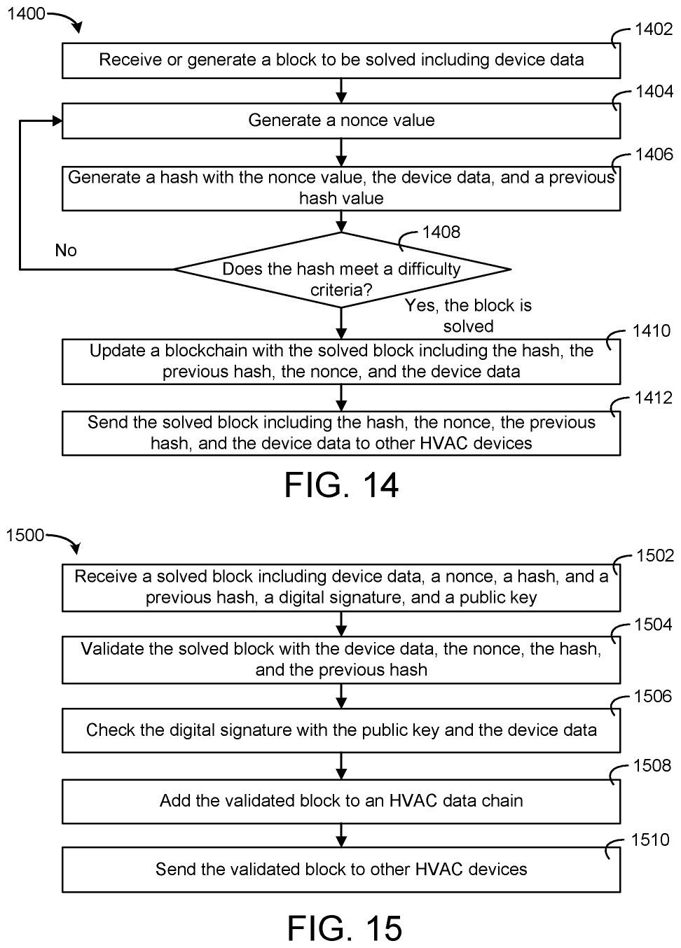

Referring now to FIG. 14, a process 1400 is shown for solving a block and adding the block to HVAC data chain 510, according to an exemplary embodiment. HVAC devices 1-6 of FIG. 5, carbon credits server 608 of FIG. 7, and/or any other device described herein can be configured to perform process 1400. Process 1400 is described with reference to HVAC device 1 and/or the components of HVAC device 1, however, process 1400 can be performed by any of the devices described herein and is not limited to HVAC device 1.

At 1402, block controller 920 receives a block to be solved and/or generates a new block to be solved. In some embodiments, when block controller 920 generates a new block, block controller 920 tries to solve the block and/or sends the block to HVAC devices 2-6 to be solved. The generated and/or received block can include device data such as device data 934 as described with reference to FIG. 9.

At 1404, nonce controller 926 generates a nonce value. In some embodiments, 1404 is a recurring step, that is, it takes multiple attempts to generate a nonce value that results in a solution for the block received and/or generated at 1402. In this regard, the nonce value can be incremented every iteration of steps 1404-1408. In the event that the nonce value overflows, that is, reaches its maximum value and resets to zero, nonce controller 926 can increment an extra nonce and hash the extra nonce when performing the hashing step 1406. This can allow HVAC device to attempt more solutions than the number of solutions presented by the maximum value of the nonce value generated at 1404.

At 1406, block controller 920 generates a hash value with the nonce value of step 1404, the device data, and a previous hash value. The previous hash value may be the hash solution of the previous block of HVAC data chain 510.

At 1408, block controller 920 determines if the hash value generated at 1406 meets a difficulty criteria. The difficulty criteria can be that the hash value is below a predefined value and/or that the first predefined number of entries are all zero. In response to determining that the hash meets the difficulty requirement, process 1400 proceeds to 1410. In response to determining that the hash does not meet the difficulty requirement, process 1400 proceeds to step 1404.

At 1410, block controller 920 can add the solved block to HVAC data chain 510. The solved block can include the device data received at 1402, the nonce value generated at 1404, the hash generated at 1406, and the hash value of the previous block of HVAC data chain 510. At 1412 block controller can send the solved block including the hash, the nonce, the previous hash, and the device data to other HVAC devices, such as HVAC devices 2-6. HVAC devices 2-6 can validate the solved block and add the solved block to the HVAC data chain 510 stored on each of HVAC devices 2-6 respectively.

Referring now to FIG. 15, a process 1500 for validating a block and adding the block to HVAC data chain 510 is shown, according to an exemplary embodiment. HVAC devices 1-6 of FIG. 5, carbon credits server 608 of FIG. 7, and/or any other device described herein can be configured to perform process 1500. Process 1500 is described with reference to HVAC device 1 and/or the components of HVAC device 1, however, process 1500 can be performed by any of the devices described herein and is not limited to HVAC device 1.

At 1502, block controller 920 receives a solved block. The block can be a block that has been solved by one of HVAC devices 2-6. The solved block can include device data (e.g., device data 934), a nonce value, a hash value, a previous hash value, a digital signature and a public key. At 1504, block controller 920 can be configured to validate the block with the device data, the nonce, the hash, and the previous hash. In some embodiments, the previous hash is the hash of the newest (e.g., most recent) block in HVAC data chain 510. In some embodiments, block controller 920 generates a hash from the device data, the nonce, and the previous hash. Block controller 920 can compare the generated hash to the hash received at 1502 to verify that the hash received at 1502 is a valid solution for the solved block.

At 1506, block controller 920 can be configured to authenticate the solved block. The solved block can include a public key and a signature. The public key, the signature, and the device data can be used to verify the authenticity of the solved block. The particular device that originally generated the block can sign the device data with a private key and include the signature and the public key in the block. For this reason, block controller 920 can verify that the particular device actually generated the block that the block is not being “spoofed” and/or being faked by an entity other than the particular device. At 1508, block controller 920 can be configured to add the validated block to HVAC data chain 510. At 1510, block controller 920 can send the solved block to other device of HVAC devices 2-6.

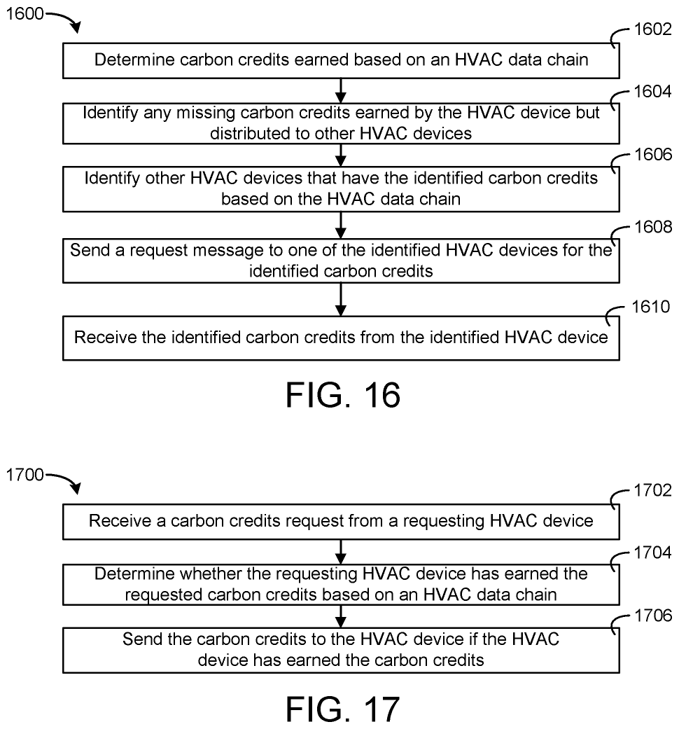

Referring now to FIG. 16, a process 1600 for determining carbon credits earned by an HVAC device and transferring carbon credits among HVAC devices is shown, according to an exemplary embodiment. HVAC devices 1-6 of FIG. 5, carbon credits server 608 of FIG. 7, and/or any other device described herein can be configured to perform process 1600. Process 1600 is described with reference to HVAC device 1 and/or the components of HVAC device 1, however, process 1600 can be performed by any of the devices described herein and is not limited to HVAC device 1. Process 1600 can be used to compare the amount of carbon credits earned by each HVAC device with the actual amount of carbon credits stored by the HVAC device for embodiments in which there is a distinction between the information stored in HVAC data chain 510 and the actual amount of carbon credits stored in each HVAC device. However, it is contemplated that process 1600 may be unnecessary for embodiments in which HVAC data chain 510 is the sole or controlling source of information regarding the carbon credit balance of each HVAC device and it is unnecessary to store the actual carbon credits separately from the information in HVAC data chain 510.

At 1602, carbon and access controller 960 determines the amount of carbon credits earned by HVAC device 1 based on HVAC data chain 510. HVAC data chain 510 can include carbon credit blocks generated by carbon credits server 608. The authenticity of these blocks can be confirmed by HVAC devices 1-6 based on a signature of the block and a public key of carbon credits server 608, server public key 616. At 1604, based on the amount of carbon credits earned, credits and access controller 960 can identify one or more amounts of carbon credits that HVAC device 1 should have but is currently missing based on the carbon credit entitlements for HVAC device 1 and the carbon credits actually received by or stored on HVAC device 1.

At 1606, HVAC device 1 can determine other devices to which carbon credits server 608 has distributed the carbon credits to which HVAC device 1 is entitled based on HVAC data chain 510. At 1608, HVAC device 1 can send a request for the identified carbon credits to the other HVAC devices and/or the carbon credits server 608. At 1610, HVAC device 1 can receive the identified carbon credits from the other HVAC devices and/or carbon credits server 608.

Referring now to FIG. 17, a process 1700 for validating a carbon credits request based on the HVAC data chain 510 and sending carbon credits to the device requesting the carbon credits is shown, according to an exemplary embodiment. HVAC devices 1-6 of FIG. 5, carbon credits server 608 of FIG. 7, and/or any other device described herein can be configured to perform process 1700. Process 1700 is described with reference to HVAC device 1 and/or the components of HVAC device 1, however, process 1700 can be performed by any of the devices described herein and is not limited to HVAC device 1. Similar to process 1600, it is contemplated that process 1700 may be unnecessary for embodiments in which HVAC data chain 510 is the sole or controlling source of information regarding the carbon credit balance of each HVAC device and it is unnecessary to store the actual carbon credits separately from the information in HVAC data chain 510.

At 1702, credits and access controller 960 can receive a carbon credits request from a requesting HVAC device. The carbon credits request can be a request for HVAC device 1 for a particular amount of carbon credits. At 1704, credits and access controller 960 can determine whether the requesting HVAC devices has earned or is otherwise entitled to the requested carbon credits based on HVAC data chain 510. At 1706, in response to determining that the requesting HVAC device has earned or is otherwise entitled to the requested carbon credits, credits and access controller 960 can be configured to send the requested carbon credits to the requesting HVAC device.

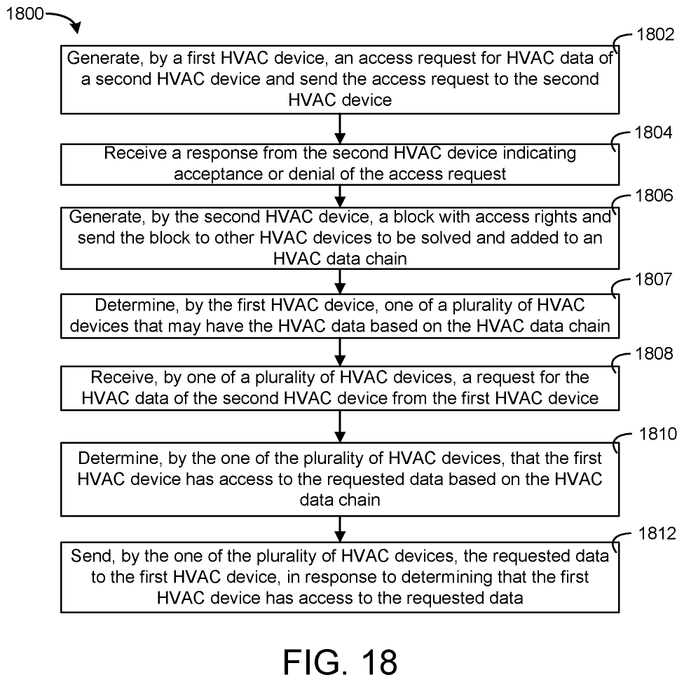

Referring now to FIG. 18, a process 1800 is shown for granting a first HVAC device access rights to HVAC data of a second HVAC device. HVAC devices 1-6 of FIG. 5, carbon credits server 608 of FIG. 7, and/or any other device described herein can be configured to perform process 1800. Process 1800 is described with reference to HVAC device 1 and/or the components of HVAC device 1, however, process 1800 can be performed by any of the devices described herein and is not limited to HVAC device 1. The first HVAC device, the second HVAC device, the one of the plurality of HVAC devices, and the plurality of HVAC devices can be HVAC devices 1-6, carbon credits server 608, and/or any other device described herein.

At 1802, the first HVAC device can generate an access request message for HVAC data of a second HVAC device and send the access request to the second HVAC device. At 1804, the second HVAC device can send a response to the first HVAC device. The response can indicate that the second HVAC device has granted the first HVAC device access to the requested HVAC data.

At 1806, the second HVAC device can add a block with access rights for the second HVAC device to the HVAC data requested at 1802 to HVAC data chain 510 by sending the block to other HVAC devices to be solved. At 1807, the first HVAC device can determine one of a plurality of HVAC devices that can have the HVAC data based on HVAC data chain 510. In some embodiments, the first HVAC device determines that the one of the plurality of HVAC devices has access to the HVAC device data that the first HVAC device also has access to. In this regard, it is possible that the one of the plurality of HVAC devices is currently storing the HVAC data of the second HVAC device.

At 1808, one of a plurality of HVAC devices can receive a request for HVAC data of the second HVAC device from the first HVAC device. At 1810, based on the HVAC data chain and the block generated by the second HVAC device at 1806, the one of the plurality of HVAC devices can determine whether the first device has access to the HVAC data of the second HVAC device. At 1812, in response to determining that the first HVAC device has access to the HVAC data of the HVAC device, the one of the plurality of HVAC devices can send the requested HVAC data of the second device to the first HVAC device if the one of the plurality of HVAC devices stores the HVAC data of the second HVAC device.

Carbon Credit System with Blockchain

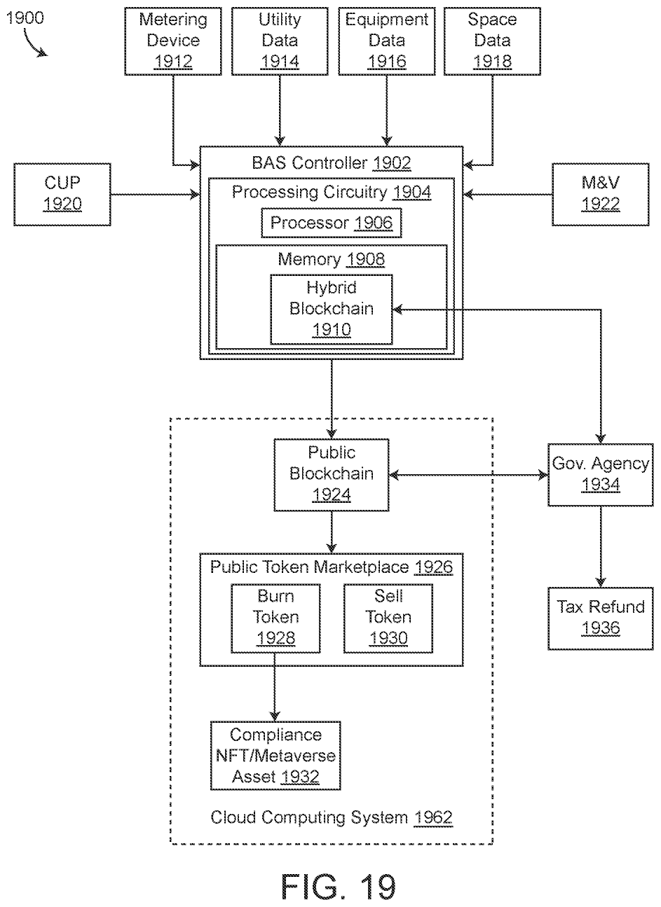

Referring to FIG. 19, a system 1900 (e.g., a building energy system) is configured to implement any of the blockchain or cryptocurrency techniques described in greater detail above with reference to FIGS. 5-18, according to some embodiments. In some embodiments, the system 1900 is configured to generate credits, cryptocurrencies, tokens, blocks, etc., of a blockchain architecture that represent, are tied to, or are linked to an amount of carbon emission reduction (e.g., carbon credits) for the building 10, sub-systems of the building 10, or devices of the building 10. In some embodiments, the system 1900 may be applicable to multiple buildings 10 of a campus of buildings 10 that is owned by a campus administrator. In some embodiments, the system 1900 can be used in order to generate tokens of carbon credits (e.g., tokens that are linked or tied to carbon emission reductions) for multiple different buildings (e.g., in a region, commonly owned buildings, different types of buildings, etc.). Advantageously, the system 1900 described herein utilizes blockchain technologies in combination with HVAC or building specific management techniques in order to generate tokens that are tied to carbon emission reductions that can be used to purchase carbon credits, sold on a public token marketplace, or redeemed in tax refunds with a government agency. In some embodiments, the tokens are non-fungible tokens (NFTs) that are associated with a particular address (e.g., a wallet address that owns the NFTs). In some embodiments, the tokens are visible to public users through a public blockchain or public ledger. In some embodiments, amounts of earned tokens can be used by the system 1900 to allow the associated wallet address with access to a Metaverse location or virtual environment.

Referring still to FIG. 19, the system 1900 includes a building automation system (BAS) controller 1902 that is configured to receive data from one or more metering devices 1912, utility data 1914, equipment data 1916, and/or space data 1918. The metering devices 1912 may be meters that are installed on solar panels, wind turbines, biomass energy, geothermal energy, solar shingles, water turbine energy, or any other energy generation devices or equipment that are configured to generate electrical energy for the building 10 or equipment of the building 10. The metering devices 1912 can also be configured to monitor or record an amount of energy consumption of fossil fuel consuming devices. Accordingly, carbon credits can also be generated for reducing the amount of fossil fuels consumed by the fossil fuel consuming devices. In some embodiments, the BAS controller 1902 uses the readings of the metering devices 1912 to quantify an amount of green electrical energy that has been generated, and a corresponding carbon emissions equivalent (e.g., a reduction of carbon emissions due to generating and using green energy instead of purchasing energy that is produced from a process that results in carbon emissions).

The BAS controller 1902 can also obtain utility data 1914 (e.g., from a utility provider, from an energy provider, etc.). In some embodiments, the utility data 1914 includes historical metering data, historical electrical energy consumption of a particular customer or building, historical natural gas consumption of a particular customer or building, a monetary cost per unit of electrical energy or natural gas, a carbon emissions cost per unit of electrical energy or natural gas, etc. In some embodiments, the utility data includes an amount of electrical energy that is consumed by a building (e.g., the building 10), multiple buildings 10 of a campus, a total energy consumption of a campus of buildings 10, energy consumption of a particular piece or unit of building equipment (e.g., chillers, VRF units, boilers, etc.), or electrical energy consumption of any other building, equipment, collection of spaces or equipment, collections of buildings, etc. In some embodiments, the BAS controller 1902 is also configured to obtain data from one or more electrical meters that are configured to measure metered amounts of electrical energy, natural gas consumption, etc., of any building, collection of buildings, equipment, collection of equipment, etc. In some embodiments, the BAS controller 1902 is configured to generate a baseline for the building 10 (e.g., baseline or expected energy consumption) using the utility data 1914 so that subsequent changes in electrical energy consumption (e.g., reduction in purchased electricity from a power grid, improved efficiency control algorithms that result in reduced electrical energy consumption, reduced amount of electrical energy consumption due to installation of higher efficiency equipment, reduced amount of electrical energy consumption due to incentive programs for occupants to use less energy, reduced amount of electrical energy consumption due to installation of higher efficiency energy consuming devices such as lighting devices, etc.) can be compared to the baseline to identify a corresponding reduction in carbon emissions.

The BAS controller 1902 can also obtain equipment data 1916 from various controllers, microcontrollers, etc., of equipment in the building 10 or multiple buildings 10. In some embodiments, the equipment data 1916 is obtained via a communications network (e.g., a backbone information network of the building 10, a wireless network of the building 10, a wired network of the building 10, etc.). In some embodiments, the equipment data 1916 includes indications of equipment type, equipment degradation, sensor data of the equipment, energy consumption of the equipment, setpoints of the equipment, operating parameters of the equipment, etc.

The BAS controller 1902 can also obtain space data 1918 from one or more sensors (e.g., temperature sensors, humidity sensors, environmental condition sensors, etc.), systems (e.g., control systems, control loops, etc.) or sub-systems of the building 10. In some embodiments, the space data 1918 includes data regarding current or historical environmental conditions of one or more spaces of the building 10, sizes of the spaces of the building 10, thermal heat transfer characteristics of the spaces of the building 10 (e.g., heat capacitance, heat resistance, heat storage, etc.).

The BAS controller 1902 is also configured to communicate with a measurement and verification system 1922 and a Central Utility Plant (CUP) application 1920. In some embodiments, the CUP application 1920 is performed by the BAS controller 1902, by a cloud computing system, by a separate server, by an on-premise server, by an off-premise server, etc. In some embodiments, the CUP application 1920 is configured to perform any of the functionality of the systems and methods described in U.S. application Ser. No. 15/473,496, filed Mar. 29, 2017, the entire disclosure of which is incorporated by reference herein. In some embodiments, the BAS controller 1902 is also configured to communicate with a measurements and verification (MV) application 1922 that may similarly be performed by the BAS controller 1902, a different controller, a separate server, a cloud computing system, an on-premise server, an off-premise server, etc. In some embodiments, the MV application 1922 is configured to perform any of the functionality of the systems or methods described in U.S. application Ser. No. 13/485,682, filed May 31, 2012, the entire disclosure of which is incorporated herein by reference.

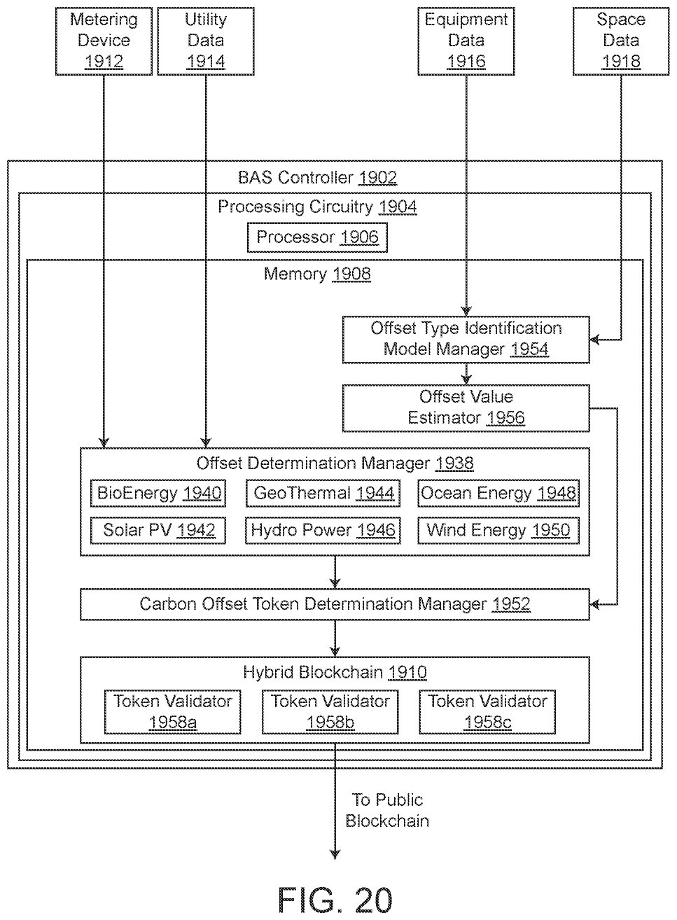

Referring particularly to FIG. 20, the BAS controller 1902 includes processing circuitry 1904 including a processor 1906 and memory 1908. Processor 1906 can be a general purpose or specific purpose processor, an application specific integrated circuit (ASIC), one or more field programmable gate arrays (FPGAs), a group of processing components, or other suitable processing components. Processor 1906 can be configured to execute computer code and/or instructions stored in memory 1908 or received from other computer readable media (e.g., CDROM, network storage, a remote server, etc.).

Memory 1908 can include one or more devices (e.g., memory units, memory devices, storage devices, etc.) for storing data and/or computer code for completing and/or facilitating the various processes described in the present disclosure. Memory 1908 can include random access memory (RAM), read-only memory (ROM), hard drive storage, temporary storage, non-volatile memory, flash memory, optical memory, or any other suitable memory for storing software objects and/or computer instructions. Memory 1908 can include database components, object code components, script components, or any other type of information structure for supporting the various activities and information structures described in the present disclosure. Memory 1908 can be communicably connected to processor 1906 via processing circuitry 1904 and can include computer code for executing (e.g., by processor 1906) one or more processes described herein.

Memory 1908 is shown to include an offset type identification model manager 1954, an offset value estimator 1956, and an offset determination manager 1938. In some embodiments, the offset determination manager 1938 is configured to determine an offset amount (e.g., an offset or reduction in electrical energy purchased from an energy provider, or an offset or amount of green energy produced by one or more energy generation devices) based on the utility data 1914 and the metering devices 1912. For example, the offset determination manager 1938 may use the metering device 1912 to determine and tag offsets of green energy, including but not limited to, BioEnergy offsets 1940, solar photovoltaics (PV) offsets 1942, GeoThermal offsets 1944, hydro power offsets 1946, ocean energy offsets 1948, and/or wind energy offsets 1950. In some embodiments, the offset determination manager 1938 is configured to use the data provided by the metering devices 1912 and the utility data 1914 to determine amounts of generation of electrical energy by one or more green energy sources, and corresponding reductions in the electrical energy purchased from an energy provider (e.g., the impact that the data from the metering devices 1912 may have on the utility data 1914 or corresponding energy consumption). The offset determination manager 1938 may provide the offset amount (e.g., the reduction of purchased electrical energy from the grid, the offset amount of green energy produced, etc.) to a carbon offset token determination manager 1952.

The offset type identification model manager 1954 may obtain the equipment data 1916 and the space data 1918 and determine or select a model based on the type of equipment (e.g., as provided or indicated by the equipment data 1916). In some embodiments, the offset type identification model manager 1954 identifies, based on characteristics of the equipment data and/or the space data 1918, a type of the equipment and selects the corresponding model for the equipment. The offset type identification model manager 1954 may provide the model for the equipment, the equipment data 1916, and the space data 1918 to an offset value estimator 1956.

The offset value estimator 1956 is configured to use the model of the equipment, the equipment data 1916, and the space data 1918 to determine an offset (e.g., a reduction in energy consumption of the equipment due to improved operation, replaced component, the performance of maintenance, upgrade of equipment, etc.). In some embodiments, the offset value estimator 1956 is configured to convert or determine a corresponding carbon offset. The offset value estimator 1956 provides the offset to the carbon offset token determination manager 1952 in order to generate a carbon offset token for a hybrid blockchain 1910 and/or a public blockchain 1924.

The carbon offset token determination manager 1952 receives the offsets (e.g., the carbon emission reduction offset, herein referred to as the carbon offsets) and is configured to generate a token (e.g., a carbon offset token) based on the carbon offsets. In some embodiments, each carbon offset token has an associated value or amount of carbon emissions reductions and is generated as a result of carbon emissions reductions. Accordingly, each carbon offset token is backed by a resulting amount of carbon emissions reduction and quantitatively represents the corresponding amount of carbon emissions reductions. In this way, the carbon offset tokens are backed by carbon emissions reductions and can be used as a form of cryptocurrency. In some embodiments, the carbon offset tokens may have a corresponding monetary or other cryptocurrency value.

The carbon offset token determination manager 1952 may provide the determined carbon offset tokens (and the associated wallet address) as inputs to a next block of the hybrid blockchain 1910. In some embodiments, the hybrid blockchain 1910 is a proof of work or a proof of stake blockchain. In some embodiments, the BAS controller 1902 is configured to use any of the blockchain or cryptographic techniques described in greater detail above with reference to FIGS. 5-18. In some embodiments, the hybrid blockchain 1910 is owned and performed on infrastructure or devices of the owner of the building 10 or an owner of a campus of buildings 10. For example, the hybrid blockchain 1910 may be implemented on different nodes or devices that include processing circuitry such as field controllers of the building 10. In some embodiments, the carbon offset tokens are NFTs associated with a specific address (e.g., a wallet address of the owner of the building 10). In some embodiments, the carbon offset tokens include attributes including but not limited to (i) an indication of an offset type (e.g., BioEnergy, GeoThermal, ocean energy, solar PV, hydro power, wind energy, etc.), (ii) an indication of an offset threshold, (iii) a date and time that the carbon offset token is generated, (iv) whether a source of the carbon offset is from a meter or estimated (e.g., based on an equipment model), (v) specific addresses of one or more validators of the carbon offset token, and/or (vi) time series data of the metering devices 1912, the utility data 1914, the equipment data 1916, the space data 1918, or any other time series data that is used to generate the carbon offset token. In some embodiments, if the carbon offset tokens do not include the time series data used to generate the carbon offset tokens, the carbon offset tokens include pointers to locations where the time series data can be read and used to validate the carbon offset token. In some embodiments, one or more compliance rules of the hybrid blockchain 1910 ensure that the BAS controller 1902 or any other database store the time series data for a certain amount of time (e.g., a year) so that the time series data can be used (e.g., by the government agency 1934) to validate the carbon offset tokens. In some embodiments, any of the time series data used to generate the carbon offset tokens are stored in an OpenBlue digital platform as provided by Johnson Controls or any other cloud computing system or database.

In some embodiments, the hybrid blockchain 1910 and new blocks in the hybrid blockchain 1910 are validated by one or more token validators 1958 (e.g., token validator 1958a, token validator 1958b, and token validator 1958c). The token validators 1958 may be configured to use the time series data of the carbon offset tokens and perform similar processes of the carbon offset token determination manager 1952 as described herein to validate the carbon offset tokens and new blocks of the hybrid blockchain 1910. In some embodiments, the token validators 1958 are configured to use all of the previous entries of the hybrid blockchain 1910 as inputs for the subsequent block of the hybrid blockchain 1910 as well as the newly determined carbon offset token. In some embodiments, the token validators 1958 are configured to perform similar functionality as the validator 924 as described in greater detail above with at least reference to FIG. 11 (e.g., using a hash function, a hash comparator, inputs from a previously solved block, etc.). In some embodiments, the token validators 1958 are selected randomly for validating the new block and carbon offset tokens of the hybrid blockchain 1910 based on an amount of carbon offset tokens that the validators 1958 have staked in the hybrid blockchain 1910 (e.g., proof of stake). The token validators 1958 may be implemented on various field controllers or devices throughout the building 10 or on various networked devices of the building 10 or infrastructure network thereof. The various field controllers or networked devices of the building 10 may share the newly updated public ledger between each other once the new block and carbon offset tokens have been validated.

Referring again to FIG. 19, the hybrid blockchain 1910 may be restricted from public access and viewing but may be accessible to a government agency 1934. The government agency 1934 may view the public ledger of the hybrid blockchain 1910 and verify that the carbon offset tokens have been accurately determined. The government agency 1934 may also, in some embodiments, view or inspect the time series data of the metering devices 1912, the utility data 1914, the equipment data 1916, the space data 1918, etc., that are used to determine the carbon offset tokens in order to verify that the carbon offset tokens are accurately determined. In some embodiments, the hybrid blockchain 1910 includes a list of all sensors, devices, readings from sensors, energy meters, etc., that are used to determine each of the carbon offset tokens so that the carbon offset tokens can be verified or validated.

Referring to FIGS. 19 and 20, the MV application 1922 may provide measurement and verification data to the carbon offset token determination manager 1952 which may use the measurement and verification data to determine the carbon offset tokens. In some embodiments, the CUP application 1920 is configured to provide energy savings data that is determined based on facility improvement measures (FIMs) such as upgrades of equipment or HVAC sub-systems or system, repairing faults of building HVAC equipment, etc. In some embodiments, the carbon offset token determination manager 1952 is configured to use the energy savings data (e.g., relative to a baseline energy consumption of the building 10) in order to determine the carbon offset tokens (e.g., to determine the carbon emissions reductions due to the energy savings). As described herein, the carbon offset determinations as performed by the offset determination manager 1938 or the offset value estimator 1956 can be performed by comparing energy usage of the building 10, or components of the building 10 (e.g., building equipment) to offset thresholds (e.g., a required threshold or amount of carbon offset required in order to obtain a carbon offset token) in order to determine the carbon offsets. In some embodiments, the carbon offset determinations are performed based on the data from the metering devices 1912, the energy generation of various green energy sources, equipment data, demand reduction, the measurement and verification data provided by the MV application 1922, demand response of the building 10 or a campus of buildings 10 relative to a baseline.

Referring again to FIG. 19, the BAS controller 1902 can provide the hybrid blockchain 1910 as an input to a new block of the public blockchain 1924. In some embodiments, all of the data of the hybrid blockchain 1910 is provided as a single token to the public blockchain 1924. In some embodiments, the public blockchain 1924 is Ethereum, Solana, Cardano, etc. In some embodiments, the public blockchain 1924 is a proof of work, proof of stake, and/or proof of history blockchain. In some embodiments, the public blockchain 1924 is a publicly accessible blockchain such that the ledger of the public blockchain 1924 is viewable by the public. In some embodiments, the public may view specific carbon offset tokens and their associated addresses (e.g., wallet addresses that own the carbon offset tokens). In some embodiments, the carbon offset tokens may be used as an asset or cryptocurrency on the public blockchain 1924 and can be sold or purchased by the various owners of the carbon offset tokens. In some embodiments, the carbon offset tokens can be burned (e.g., illustrated by burn tokens 1928 operation) or sold (e.g., transferred to a different wallet as a transaction, illustrated by sell token 1930 operation) in a public token market place 1926. The carbon offset tokens can also be transformed into or used to purchase an NFT or a metaverse asset 1932, shown as compliance NFT/metaverse asset 1932. The public blockchain 1924 may include various validators (similar to the hybrid blockchain 1910) or nodes implemented on various devices, computers, networked devices, etc., that are distributed geographically and open to the public. In some embodiments, the validators are members of various staking pools that allow multiple stakeholders in the public blockchain 1924 to combine their computational resources to validate new blocks of the public blockchain 1924 (including the sidechain input of the hybrid blockchain 1910). In some embodiments, the public blockchain 1924 and the public token marketplace 1926 are implemented on a cloud computing system 1962 that includes multiple distributed devices (e.g., different nodes) having processing circuitry configured to implement validation operations, cryptographic operations, store a public ledger, etc.

In some embodiments, the owners of the carbon offset tokens can redeem the carbon offset tokens through the government agency 1934 for a tax refund 1936. For example, the government agency 1934 may provide a tax refund to the owner (e.g., the wallet address and associated business or individual) of the carbon offset tokens for burning the carbon offset tokens or selling the carbon offset tokens to the government agency 1934 in exchange for the tax refund.

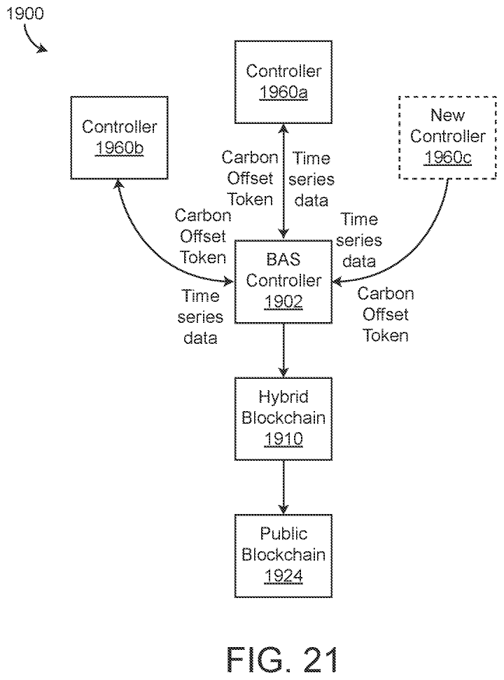

Referring to FIG. 21, BAS controller 1902 is configured to receive carbon offset tokens and time series data from one or more controllers 1960. For example, the controllers 1960 may include processing circuitry, a processor, and memory, similar to the BAS controller 1902 as shown in FIG. 20. In some embodiments, the controllers 1960 are equipment controllers, controllers of metering devices, controllers of green energy generation systems or devices (e.g., BioEnergy, GeoThermal energy, ocean energy, solar PV, hydro power, wind energy, etc.) controllers of HVAC equipment, servers, microservice controllers, lighting controllers, etc. The controllers 1960 are configured to implement any of the offset determination and/or carbon offset token determination techniques described in greater detail above with reference to FIGS. 19 and 20. In some embodiments, the controllers 1960 are configured to operate as validators for the hybrid blockchain 1910 and may each store the public ledger of the hybrid blockchain 1910. It should be understood that the public ledger of the hybrid blockchain 1910 is public in that the ledger is accessible and stored on all of the controllers 1960 of the building 10 or the manager of the building 10 but not necessarily accessible to unauthenticated individuals.

In some embodiments, the controllers 1960 are also configured to provide time series data to the BAS controller 1902 and/or the other controllers 1960 so that the BAS controller 1902 and/or the other controllers 1960 can validate new blocks in the hybrid blockchain 1910. In some embodiments, the carbon offset tokens as determined by the controllers 1960 and/or the BAS controller 1902 are added to both the hybrid blockchain 1910 and the public blockchain 1924. The hybrid blockchain 1910 can be stored in and updated with new blocks in a distributed manner across the controllers 1960 and the BAS controller 1902. It should be understood that the system 1900 may include any number of controllers 1960 or devices that participate in storing the hybrid blockchain 1910 and/or ledger thereof, generating carbon offset tokens, generating new blocks, and/or validating new blocks and new carbon offset tokens in a decentralized or cooperative manner. Any of the controllers 1960 can be configured to perform any of the operations of the carbon offset token determination manager 1952, the offset determination manager 1938, the offset value estimator 1956, and/or the offset type identification model manager 1954.

Once transactions in the hybrid blockchain 1910 are created in the new blocks of the hybrid blockchain 1910 (e.g., new carbon offset tokens are created and validated, as well as the new blocks of the hybrid blockchain 1910 that include new transactions such as carbon offset token creation), the transactions may be immutable, since changing a transaction in a previous block will cause all of the subsequent blocks to fail (since the previous hashes of the preceding solved blocks of the hybrid blockchain 1910 are all provided as inputs to the has function of the most recent block). Advantageously, using the hybrid blockchain 1910 facilitates improved assurance and trust that the carbon offset tokens accurately reflect actual carbon emissions reductions that are either measured (e.g., when the carbon offset tokens are determined or created based on the data provided by the metering devices 1912 and the utility data 1914), or estimated based on changes in equipment performance (e.g., when the carbon offset tokens are determined or created based on the equipment data 1916 and/or the space data 1918).

Referring again to FIG. 20, the carbon offset token determination manager 1952 may be configured to perform one or more trust functions (e.g., implement a trust module) in order to ensure the accuracy of time series data used to create the carbon offset tokens. In some embodiments, the carbon offset token determination manager 1952 is configured to implement one or more cyphers or puzzles and validate results of the cyphers or puzzles across the hybrid blockchain 1910 in order to validate data sources that are used to create the carbon offset tokens. In some embodiments, the data sources (e.g., sensors, meters, equipment, etc.) include data water stamps or keys that can be validated to ensure the veracity of the data sources and time series data thereof. In some embodiments, the carbon offset tokens include proof indicating how the token was created so that the carbon offset tokens can be validated as determined using verifiable data sources and time series data. In some embodiments, the carbon offset tokens or the time series data obtained from the data sources (e.g., sensors, metering devices 1912, utility data 1914, equipment data 1916, space data 1918, etc.) include a hash that is created based on a point in time at which the time series data is obtained from the data sources. The carbon offset tokens can also include an identification of an application that was used to create the time series data used to create the carbon offset tokens, and/or a version of the software used by devices, sensors, or meters that provide the time series data used to create the carbon offset tokens.

Referring to FIG. 21, when a new controller 1960c joins the system 1900 (e.g., communicably connects with a network that the BAS controller 1902 and the controllers 1960), the new controller 1960 may implement the functionality as described herein with reference to FIGS. 19-20 and report time series data and carbon offset tokens that the new devices 1960c is entitled to. The controllers 1960a and 1960b, or the BAS controller 1902 may perform the functions described herein with reference to FIGS. 19-20 in order to validate that the new controller 1960c is entitled to the carbon offset tokens (e.g., whether the carbon offset tokens provided by the new controller 1960c are valid or not).

Referring still to FIG. 21, any of the controllers 1960 that interact with the BAS controller 1902 may forward their data to a BAS server (e.g., the BAS controller 1902). Each of the controllers 1960 (e.g., engines or nodes of the system 1900 that implement or support the hybrid blockchain 1910) may determine their own carbon offset token entitlements. In some embodiments, any information needed to validate new blocks of the hybrid blockchain 1910 or the carbon offset tokens are included in a payload of a previous block of the hybrid blockchain 1910. In some embodiments, all the controllers 1960 that interact with the BAS controller 1902 and operate to support and implement the hybrid blockchain 1910 have their own MAC addresses and require permission to join the network to implement the functionality to generate carbon offset tokens and validate new blocks of the hybrid blockchain 1910. In some embodiments, the permission for the controllers 1960 can be based on whether the controllers 1960 implement necessary software or applications to generate the carbon offset tokens. In some embodiments, a list of controllers 1960 that have permission to create carbon offset tokens and validate new blocks or validate new carbon offset tokens are stored in a cybersecurity system that is accessible to the BAS controller 1902. In this way the system 1900 facilitates ensuring that the controllers 1960 are using data from a verified or trusted source. It should be understood that any form of BAS data may be used to validate that new nodes or controllers 1960 may join the system 1900 and provide trusted data. In some embodiments, the BAS controller 1902, or all of the controllers 1960 are configured to detect an unauthorized device based on a MAC or IP address of the unauthorized device, or based on one or more characteristics of communications from the unauthorized device (e.g., when the unauthorized device submits multiple erroneous token requests). In some embodiments, the BAS controller 1902 and/or the controllers 1960 are configured to exclude the unauthorized device from being assigned carbon credits.

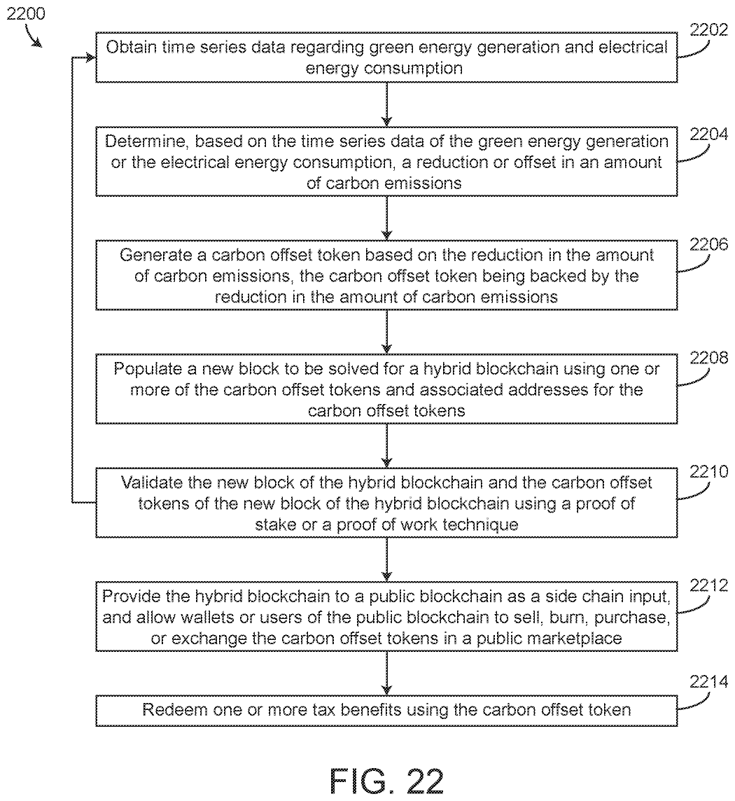

Referring to FIG. 22, a flow diagram of a process 2200 for implementing blockchain techniques and generating carbon emissions reductions backed tokens includes steps 2202-2214. The process 2200 can be performed by a BAS system, a BAS server, multiple networked devices of a building, etc. In some embodiments, one or more of the steps 2202-2214 are performed by one or more public devices to implement and support a public blockchain.

Process 2200 includes obtaining time series data regarding green energy generation and electrical energy consumption (step 2202), according to some embodiments. In some embodiments, the time series data is data that is obtained from one or more metering devices 1912, utility data 1914, equipment data 1916, energy reduction data (e.g., relative to a baseline) from CUP application 1920, and/or measurement or verification data obtained from MV application 1922. In some embodiments, the time series data is received at one or more networked devices of a BAS (e.g., the BAS controller 1902, controllers 1960, etc.). In some embodiments, the green energy generation data indicates an amount of electrical energy that is generated as a result of a process that does not cause carbon emissions, or causes reduced carbon emissions relative to carbon emissions resulting from producing electrical energy at an energy service provider power plant (e.g., a coal power plant, a natural gas power plant, etc.). The time series data of the electrical energy consumption may indicate energy savings or reductions electrical energy consumption relative to a baseline or an expected consumption level due to improved control efficiency, reduced load or demand, service of equipment, facility improvement measures, equipment upgrades, etc.

Process 2200 includes determining, based on the time series data of the green energy generation or the electrical energy consumption, a reduction or offset in an amount of carbon emissions (step 2204), according to some embodiments. In some embodiments, step 2204 can be performed by the BAS controller 1902 and/or the controllers 1960. In some embodiments, step 2204 includes determining the offset or reduction in the amount of carbon emissions by measurement data (e.g., the data obtained from the metered devices 1912 and the utility data 1914) or estimating the offset or reduction of carbon emissions using the equipment data 1916, the space data 1918, and a model (e.g., an equipment model).

Process 2200 includes generating a carbon offset token based on the reduction in the amount of carbon emissions, the carbon offset token being backed by the reduction in the amount of carbon emissions (step 2206), according to some embodiments. In some embodiments, step 2206 is performed by the BAS controller 1902 or by the controllers 1960 which report their entitled carbon offset tokens to the BAS controllers 1902. In some embodiments, the carbon offset token includes attributes including but not limited to (i) an indication of an offset type (e.g., BioEnergy, GeoThermal, ocean energy, solar PV, hydro power, wind energy, etc.), (ii) an indication of an offset threshold, (iii) a date and time that the carbon offset token is generated, (iv) whether a source of the carbon offset is from a meter or estimated (e.g., based on an equipment model), (v) specific addresses of one or more validators of the carbon offset token, and/or (vi) time series data of the metering devices 1912, the utility data 1914, the equipment data 1916, the space data 1918, or any other time series data that is used to generate the carbon offset token.

Process 2200 includes populating a new block to be solved for a hybrid blockchain using one or more of the carbon offset tokens and associated addresses for the carbon offset tokens (step 2208) and validating the new block of the hybrid blockchain and the carbon offset tokens of the new block of the hybrid blockchain using a proof of stake or a proof of work technique (step 2210), according to some embodiments. In some embodiments, step 2208 is performed by the BAS controller 1902 and/or the controllers 1960 of the system 1900. The hybrid blockchain may be a blockchain that is not accessible to the public, but is accessible to devices of the system 1900 that have appropriate permissions as well as a government agency for inspection. In some embodiments, step 2210 is performed by any of the networked devices of the system 1900 that are configured to implement proof of work or proof of stake validation techniques. In some embodiments, step 2210 includes performing any of the functionality of validator 924.

Process 2200 includes providing the hybrid blockchain to a public blockchain as a side chain input (e.g., as a single token) and allowing wallets or users of the public blockchain to sell, burn, purchase, or exchange (e.g., for an NFT, a digital asset, a metaverse asset, a metaverse digital twin of building equipment, an NFT compliance award, etc.) the carbon offset tokens in a public marketplace (step 2212), according to some embodiments. In some embodiments, performing step 2212 allows users with wallet addresses on the public blockchain to own carbon offset tokens that can be used as a coin or form of cryptocurrency.

Process 2200 includes redeeming one or more tax benefits using the carbon offset token (step 2214), according to some embodiments. Step 2214 includes providing the carbon offset token to a government agency in exchange for a payback or a tax reduction. In some embodiments, step 2214 includes participating in a tax benefit program in exchange for reducing carbon emissions, and the carbon offset tokens are used as proof of tax benefit entitlements.

### Building Certification NFTs and WEB3

A building (e.g., building 10), a facility, a campus or any other possible type of business location or structure can have and/or receive building certifications and credentials. For example, a building can receive a building certification (e.g. LEED, Energy Star, BREEAM, Well Building, etc.). The certifications can be presented, provided or otherwise displayed at the building (e.g., in the lobby, at the entrance of the building). The building can have a virtual representation, a virtual existence, etc., in the Metaverse. For example, the Metaverse can contain a replica of the physical building. As the building earns certifications, the replica of the building, in the Metaverse, can be modified, adjusted or otherwise changed to include an indication that the building has received the certification.

The systems and methods discussed and described below can generate, create, provide or otherwise present at least one Metaverse Building Certification (MBC). The MBC can be or include a non-fungible token (NFT). For example, as a building earns a certification the system can generate a MBC NFT that can be added or included in the Metaverse.

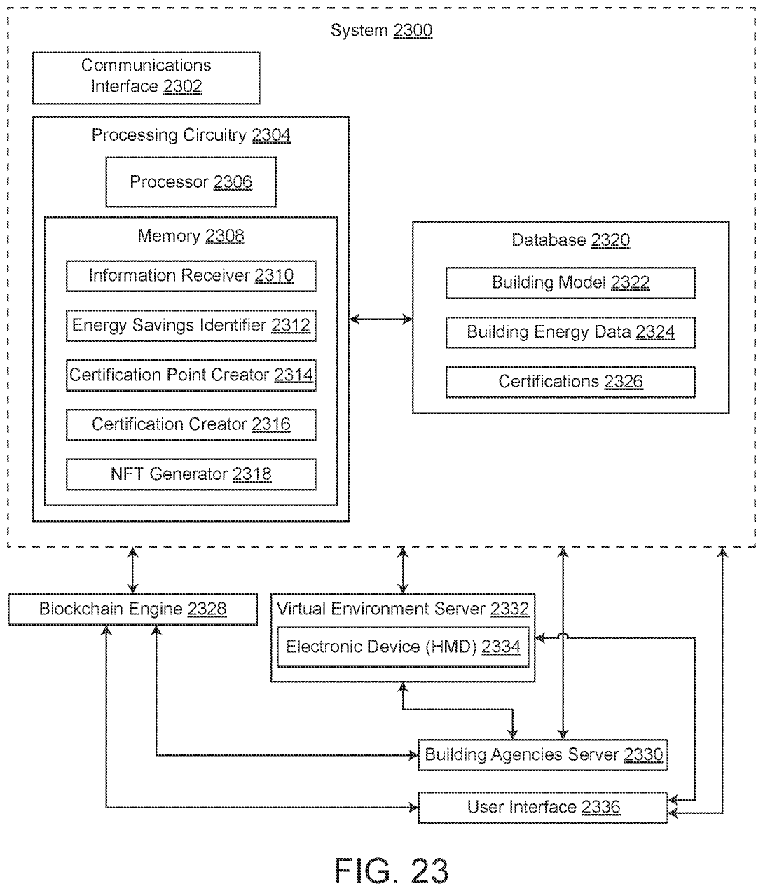

Referring to FIG. 23, a system 2300 for implementing at least one MBC and for establishing at least one NFT, according to some embodiments. The system 2300 can include at least one communications interface 2302, at least one processing circuitry 2306 and at least one database 2320. The system 2300 can communicate with, interact with, or otherwise interface with at least one of a blockchain engine 2328, a virtual environment server 2332, a building agencies server 2330 and/or a user interface 2336.

The communications interface 2302 can provide and receive data from the blockchain engine 2328, the virtual environment server 2332, the building agencies server 2330 and/or the user interface 2336. For example, the communications interface 2302 can provide, to the virtual environment server 2332, NFTs that have been generated by the system 2300 or a component thereof.

The processing circuitry 2304 can include at least one processor 2306 and memory 2308. Processor 2306 can be a general purpose or specific purpose processor, an application specific integrated circuit (ASIC), one or more field programmable gate arrays (FPGAs), a group of processing components, or other suitable processing components. Processor 2306 can be configured to execute computer code and/or instructions stored in memory 2308 or received from other computer readable media (e.g., CDROM, network storage, a remote server, etc.).

Memory 2308 can include one or more devices (e.g., memory units, memory devices, storage devices, etc.) for storing data and/or computer code for completing and/or facilitating the various processes described in the present disclosure. Memory 2308 can include random access memory (RAM), read-only memory (ROM), hard drive storage, temporary storage, non-volatile memory, flash memory, optical memory, or any other suitable memory for storing software objects and/or computer instructions. Memory 2308 can include database components, object code components, script components, or any other type of information structure for supporting the various activities and information structures described in the present disclosure. Memory 2308 can be communicably connected to processor 2306 via processing circuitry 2304 and can include computer code for executing (e.g., by processor 1906) one or more processes described herein.

Memory 2308 is shown to include an information receiver 2310, an energy savings identifier 2312, a certification point creator 2314, a certification creator 2316 and a NFT generator 2318. The information receiver 2310 can receive information and/or data from the database 2320. The database 2320 can store, hold or otherwise maintain information and/or data that pertains buildings models (e.g., building model 2322), data that pertains to energy data (e.g., building energy data 2324) and/or data that pertains to certifications (e.g., certifications 2326).

In some embodiments, the information receiver 2310 can receive certification information for one or more building components that pertain to a building model. For example, the information receiver 2310 can receive, from the database 2320, the building model 2322. The building model 2322 can include a model for a building (e.g., building 10). The building model can include information about one or more components of the building 10, information about the layout (e.g., a floor plan), location of offices, rooms, floors, spaces, etc. The building module 2322 can include or be a 3D or virtual representation of the building 10. The information receiver 2310 can, using the information included in the building model 2322, identify the components of the building 10. The information receiver 2310 can provide, to the energy savings identifier, the identified components of the building 10 and the energy data (e.g., building energy data 2324) that corresponds to the components of the building 10.

The energy savings identifier 2312 can, responsive to communicating with the information receiver 2310, identify certification energy saving components. The energy savings identifier 2312 can use the building energy data 2324 to identify certification energy saving components. For example, the energy savings identifier 2312 can determine, based on the building model 2322, that an HVAC system for the building 10 was replaced and that the building energy data 2324 that corresponds to the new HVAC indicates a reduction energy consumption. The energy savings identifier 2312 can continue to, responsive to the information receiver 2310 providing the building energy data 2324, identify and/or determine certification energy saving components. The energy savings identifier 2312 can provide, to the certification point creator 2314, the identified energy savings components.

The certification point creator 2314 can, using the identified energy saving components, create points. The points can correspond to requirements for a certification. For example, a certification standard can require that a building receive a certain amount of points (e.g., 10, 100, etc.). The points can be earned each time an energy savings component is identified. The certification point creator 2314 can, responsive to creating a point, provide, to the certification creator 2314, the point.

The certification creator 2316 can, responsive to receiving the points from the certification point creator 2314, tally the points. The certification creator 2316 can tally the points by creating a certification data set. The certification data set can include the points that have been tallied for a piece of equipment included in the building 10 or the points that pertain to the building 10 (e.g., all of the points that the pieces of equipment included in the building 10 have earned). The certification creator 2316 can, responsive to creating the certification data set, receive, from the information receiver 2310, the certification 2326. The certifications 2326 can include the standards that correspond to the certifications. For example, the certifications 2326 can include that a building receives a building certification responsive to the accumulation of 10 points. The certification creator 2316 can, responsive to determining that the building 10, has earned a certification, create, for the building 10, the certification. The certification creator 2316 can, responsive to creating the certification, communicate with the NFT generator 2318.

The certification creator 2316 can communicate, to the NFT generator 2318, an indication that the building 10 has earned a certification. The certification creator 2316 can also communicate the information that corresponds with the certification (e.g., the type of certification, what was accomplished that resulted in the certification, etc.). The NFT generator 2318 can, responsive to receiving the indication from the certification creator 2316, generate an NFT that corresponds to the certification. The NFT generator 2318 can provide the NFT to the communications interface 2302.

The communications interface 2302 can, responsive to receiving the NFT from the NFT generator 2318, provide the NFT to at least one of the blockchain engine 2328, the virtual environment server 2332, the building agencies server 2330 and/or the user interface 2336. For example, the communications interface 2302 can provide, to the blockchain engine 2328, the NFT. The NFT provided to the blockchain engine 2328 can be a MBC NFT.

The blockchain engine 2328 can receive the NFT as an input to a next block of a blockchain associated with the building 10. The blockchain engine 2328 can also generate a new blockchain, using the NFT provided by the communications interface, with the NFT as the first block. In some embodiments, the blockchain engine 2328 is configured to use any of the blockchain or cryptographic techniques described in greater detail above with reference to FIGS. 5-18.

In some embodiments, the blockchain engine 2328 and/or a blockchain created by the blockchain engine 2328 is owned and performed on infrastructure or devices of the owner of the building 10 or an owner of a campus of buildings 10. For example, the blockchain engine 2328 may be implemented on different nodes or devices that include processing circuitry such as field controllers of the building 10. In some embodiments, the NFTs can be associated with a specific address (e.g., a wallet address of the owner of the building 10). In some embodiments, the NFTs provided to the blockchain engine 2328 can include attributes or information similar to the carbon offsets tokens described herein.

In some embodiments, the virtual environment server 2332 can generate a virtual environment (e.g., a digital twin) for the building 10 and/or for the building model that pertains to building 10. For example, the virtual environment server 2332 can receive, from the communications interface 2302, the building model 2322. The virtual environment server 2332 can, using the building model 2322, generate the virtual environment for the building 10. The virtual environment server 2332 can include at least electronic device 2334. The electronic device 2334 can be or include at least one of a Head-Mounted Display (HMD), a pair of smart glasses, a mobile device, a virtual reality (VR) headset and/or any other computing device that a user can use to view or interact with the Metaverse.

The virtual environment server 2332 can, via the electronic device 2334, present, provide, display, or otherwise produce the virtual environment for the building 10. For example, the virtual environment server 2332 can provide the virtual environment for the building 10 in the Metaverse. The virtual environment server 2332 can, responsive to generating the virtual environment for the building 10, receive, from the communications interface 2302, the MBC NFTs that pertain to the building 10. The virtual environment server 2332 can, responsive to receiving the NFTs, present, via the electronic device 2334, the MBC NFTs within the virtual environment of the building 10.

The communications interface 2302 can obtain, from the building agencies server 2330, equipment information associated with one or more pieces of building equipment that can be included, implemented, associated with or pertain to a building (e.g., building 10). The equipment information can pertain to the physical piece of building equipment and/or the virtual information that pertains to the piece of building equipment. The building agencies server 2330 can be or include a digital platform, a cloud computing system or database. In some embodiments, the equipment information stored by the building agencies server 2330 can be stored in, retrieved from, or processed in the context of digital twins. In some such embodiments, the digital twins may be provided within an infrastructure such as those described in U.S. patent application Ser. No. 17/134,661 filed Dec. 28, 2020, 63/289,499 filed Dec. 14, 2021, and Ser. No. 17/537,046 filed Nov. 29, 2021, the entireties of each of which are incorporated herein by reference.

In some embodiments, various data discussed herein may be processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises. In some example implementations, the data may be processed using systems and/or methods such as those described in U.S. patent application Ser. No. 17/710,458 filed Mar. 31, 2022, which is incorporated herein by reference in its entirety.

The communications interface 2302 can, responsive to receiving the equipment information from the buildings agencies server 2330, provide the equipment information to the NFT generator 2318. The NFT generator 2318 can, responsive to receiving the equipment information from the communications interface 2302, generate, create, produce, or otherwise establish NFTs. The NFTs can be based on the equipment information. The NFT generator 2318 can provide, to the blockchain engine 2328, the NFTs.

The blockchain engine 2328 can, responsive to receiving the NFTs that pertain to the equipment information, provide the NFTs to a marketplace. For example, the blockchain engine can provide the NFTs to the public token marketplace 1926. In some embodiments, the NFTs provided to the public token marketplace 1926 can be sold. For example, the owner of the building 10 can purchase an NFT that pertains to a piece of equipment. The NFT purchased by the owner of the building 10 can be applied to building automation software (e.g., associated with the BAS controller 1902) that pertains to the building 10.

In some embodiments, the NFT can include metadata that pertains to the piece of building equipment associated with the NFT. The building automation system that has applied the NFT can be provided with software capabilities that pertain to the NFT. For example, the piece of building equipment associated with the NFT can be a lighting system and the lighting system can turn the lights on and off.

In some embodiments, the NFT that pertains to a piece of building equipment can be displayed in the virtual representation of the building automation system. For example, the building 10 can purchase a NFT that pertains to an HVAC system and the building automation system associated with the building 10 can receive the NFT that pertains to the HVAC system. The building automation system can be updated, adjusted, modified or otherwise changed to include a visual representation of the NFT.

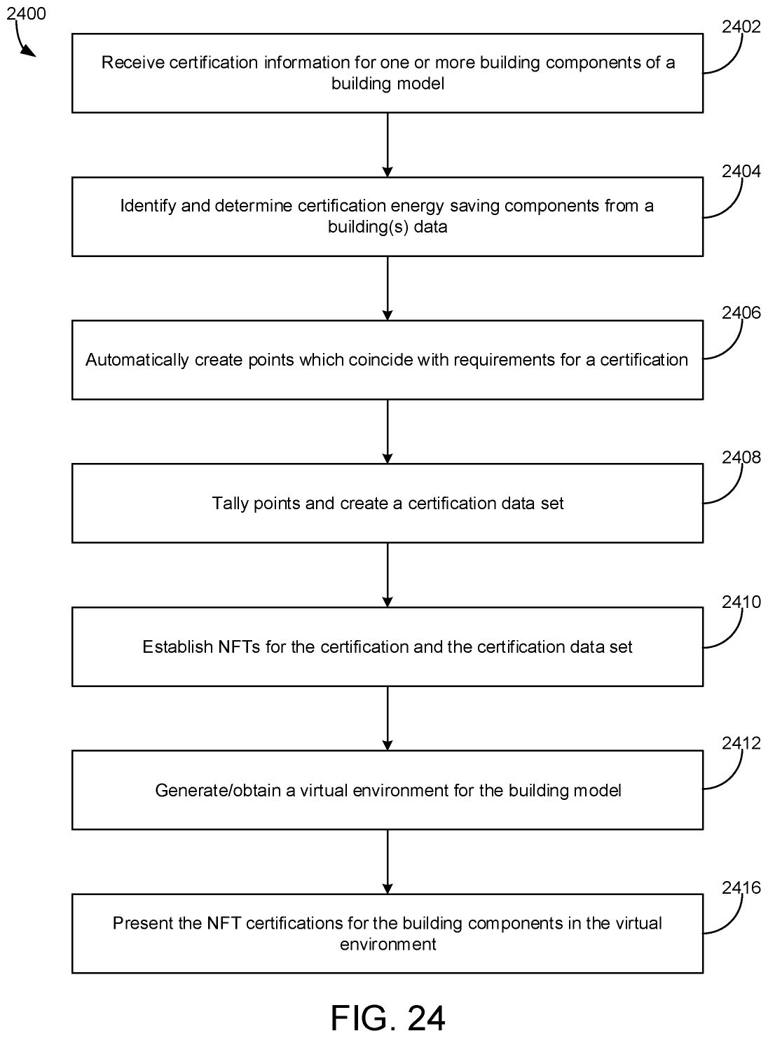

Referring now to FIG. 24, a flow diagram of a process 2400 for implementing a MBC NFT includes steps 2402-2414. The process 2400 can be performed by a BAS system, a BAS server, multiple networked devices of a building, etc. In some embodiments, one or more of the steps 2402-2414 can be performed by the system 2300 and/or a component thereof.

Process 2400 includes receiving certification information for one or more building components of a building model (step 2402), according to some embodiments. In some embodiments, the information receiver 2310 can receive certification information for one building components. For example, the information receiver 2310 can receive the certification information from the database 2320. The database 2320 can provide, to the information receiver 2310, at least one of the building model 2322, the building energy data 2324 and/or the certifications 2326. The certification information can be or include at least one of requirements, standards, milestones, regulations or any other possible guideline that results in reaching or achieving a certification. The information receiver 2310 can provide, to the energy savings identifier 2312, the information received from the database 2320.

Process 2400 includes identifying and determining certification energy saving components from building data (step 2404), according to some embodiments. The energy savings identifier 2312 can use the building energy data 2324 to identify certification energy saving components. The energy savings identifier 2312 can use the information, provided by the information receiver 2310, to identify the certification energy saving components. For example, the energy savings identifier 2312 can determine that data associated with an air filtration system indicates a reduction energy consumption. The energy savings identifier 2312 can provide the identified components to the certification point creator 2314.

Process 2400 includes creating points that correspond with requirements for a certification (step 2406), according to some embodiments. The certification point creator 2314 can create points which coincide with requirements for a certification. The certification point creator 2314 can use the certifications 2325 and the identified energy saving components to generate the points. The points can be earned each time an energy savings component is identified. The points created by the certification point creator 2314 can be provided to the certification creator 2316.

Process 2400 includes tallying points and creating a certification data set (step 2408), according to some embodiments. The certification creator 2316 can tally points by creating a certification data set. The certification creator 2316 can tally the points created by the certification point creator 2314. The certification data set created by the certification creator 2316 can include the points that have been tallied for a piece of building equipment or all of the points that have been tallied for a building. The certification creator 2316 can communicate, each time a certification is earned, with the NFT generator 2318. The certification creator 2316 can provide, to the NFT generator 2318, an indication of the certification that is earned.

Process 2400 includes establishing NFTs for the certification of the certification data set (step 2410), according to some embodiments. The NFT generator 2318 can generate NFTs that pertain to the certifications identified by the certification creator 2316. The NFTs can be MBC NFTs. The NFTs generated by the NFT generator 2318 can be provided to the communications interface 2302. The communications interface 2302 can provide the NFTs to the virtual environment server 2332.

Process 2400 includes generating/obtaining a virtual environment for the building model (step 2412), according to some embodiments. The virtual environment server 2332 can generate a virtual environment for a building model. For example, the virtual environment server 2332 can generate a virtual environment for the building model 2322.

Process 2400 includes presenting the NFT certifications for the building components in the virtual environment (step 2414), according to some embodiments. The virtual environment server 2332 can, responsive to receiving the NFTs from the communications interface 2302, present the NFT certifications in the virtual environment that was generated in step 2412.

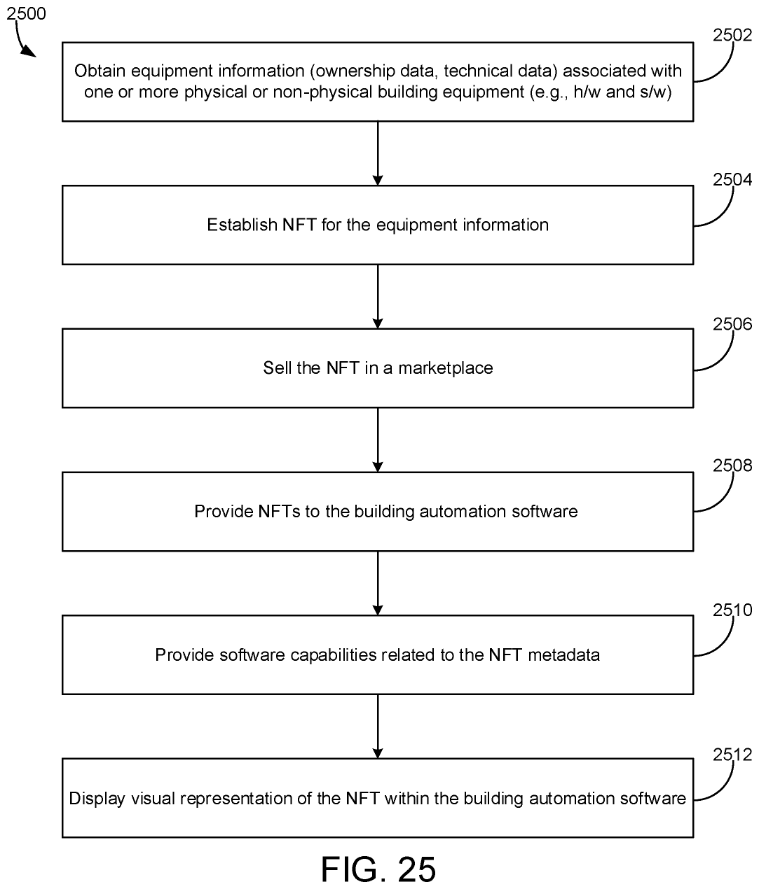

Referring now to FIG. 25, a flow diagram of a process 2500 for establishing a NFT for building equipment includes steps 2502-2512. The process 2500 can be performed by a BAS system, a BAS server, multiple networked devices of a building, etc. In some embodiments, one or more of the steps 2502-2512 can be performed by the system 2300 and/or a component thereof.

Process 2500 includes obtaining equipment information associated with one or more physical or non-physical building equipment (step 2502), according to some embodiments. The communications interface 2302 can obtain equipment information. The equipment information can include ownership data and technical data. The equipment information can be associated with physical and/or non-physical building equipment. Physical building equipment can include, for example, hardware-based devices having a housing, circuitry, processors, memory, power supplies, and/or other physical hardware (h/w) components. Non-physical building equipment can include, for example, software-based devices such as virtual devices, digital twins, virtual machines, emulated equipment, device software (s/w) or other equipment that exists in a virtual or non-physical form. The communications interface 2302 can obtain the equipment information from the building agencies server 2330. The communications interface 2302 can provide the equipment information to the NFT generator 2318.

Process 2500 includes establishing NFTs for the equipment information (step 2504), according to some embodiments. The NFT generator 2318 can establish NFTs that pertain to the physical and/or the non-physical building equipment. The NFT generator 2318 can generate, using the equipment information, at least one NFT that pertains to a piece of building equipment. The piece of building equipment can be a physical piece and/or a non-physical piece. The NFT generator 2318 can provided the NFTs to the blockchain engine 2328. The blockchain engine 2328 can provide the NFTs to a public marketplace (e.g., the public token marketplace 1926).

Process 2500 includes selling the NFTs in a marketplace (step 2506), according to some embodiments. The NFTs provided to the public marketplace by the blockchain engine 2328 can be sold. For example, the owner of the building 10 can purchase an NFT that pertains to a piece of equipment. The NFT purchased by the owner of the building 10 can be applied to building automation software that pertains to the building 10.

Process 2500 includes providing the NFTs to the building automation software (step 2508), according to some embodiments. The NFTs purchased in step 2506 can be applied to building automation software. In some embodiments, step 2506 includes displaying the NFTs or using the NFTs as a baseline for the building automation software. For example, a NFT that pertains to an HVAC system can be applied to a building automation software that pertains to building 10.

Process 2500 includes providing software capabilities related to the NFT metadata (step 2510), according to some embodiments. The NFT that has been provided to the building automation system can include software capabilities. The software capability can pertain to how the piece of equipment associated with the NFT performs (e.g., actions performed by the piece of building equipment). The building automation system can be provided software capabilities that are related to the NFT responsive to the NFT being applied to the building automation software (e.g., at step 2508).

Process 2500 includes displaying visual representations of the NFT within the building automation software (step 2512), according to some embodiments. The NFT, applied to the building automation software at step 2508, can be displayed as a visual representation within the building automation software. The NFT can pertain to a piece of building equipment and the NFT and/or the piece of building equipment can be displayed within a virtual representation of the building 10. For example, the building 10 can purchase a NFT that pertains to an HVAC system and the building automation system associated with the building 10 can receive the NFT that pertains to the HVAC system. The building automation software can be updated, adjusted, modified or otherwise changed to include a visual representation of the NFT. For example, the virtual environment server 2332 can, via the electronic device 2334, present, provide, display, or otherwise produce the virtual environment for the building 10. The virtual environment server 2332 can, responsive to generating the virtual environment for the building 10, receive, from the communications interface 2302, the NFTs that pertain to the pieces of building equipment that have been applied to the building automation software associated with the building 10. The virtual environment server 2332 can, responsive to receiving the NFTs, present, via the electronic device 2334, the NFTs within the virtual environment of the building 10.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A building automation system (BAS) for a building comprising:
a plurality of devices comprising processing circuitry configured to:
obtain time series data indicating reduced energy consumption of building equipment of the building, or green energy generation for the building;
determine a corresponding carbon emissions reduction resulting from the reduced energy consumption of the building equipment or the green energy generation;
create a carbon offset token responsive to the corresponding carbon emissions reduction being greater than a threshold;
validate a new block of a first blockchain, wherein the carbon offset token is an attribute or data of the new block of the first blockchain, the first blockchain being limited from public access; and
provide the first blockchain as an input to a new block or a sidechain of a second blockchain, the second blockchain being publicly accessible and including the carbon offset token as a result of providing the first blockchain as an input to the new block or sidechain of the second blockchain.

2. The BAS of claim 1, wherein the corresponding carbon emissions reduction is either (i) measured based on data from a metering device and utility data, or (ii) estimated based on equipment data of the building equipment, space data of a space of the building, and a model of the building equipment.

3. The BAS of claim 1, wherein the green energy generation for the building comprises any of BioEnergy, GeoThermal energy, solar photovoltaic energy, hydropower energy, ocean energy, or wind energy.

4. The BAS of claim 1, wherein new blocks of the first blockchain are validated by a plurality of validators of the building, the plurality of validators being a plurality of different networked devices of the BAS.

5. The BAS of claim 1, wherein the new block of the first blockchain are validated using a proof of work or a proof of stake consensus algorithm.

6. The BAS of claim 1, wherein the carbon offset token comprises a plurality of attributes including:
an indication of an offset type of the corresponding carbon emissions reduction;
an indication of the threshold of the corresponding carbon emissions reduction;
a date and time that the carbon offset token is created;
whether the carbon offset token is created based on meter data or estimated data;
one or more addresses of validators of the carbon offset token; and
the time series data used to create the carbon offset token.

7. The BAS of claim 1, wherein the carbon offset token is exchangeable on the second blockchain for a tax refund for an owner of the carbon offset token.

8. A method for a carbon credit blockchain for a building, the method comprising:
obtaining time series data indicating reduced energy consumption of building equipment of the building or green energy generation for the building;
determining a corresponding carbon emissions reduction resulting from the reduced energy consumption of the building equipment or the green energy generation;
creating a carbon offset token responsive to the corresponding carbon emissions reduction being greater than a threshold;
validating a new block of a first blockchain, wherein the carbon offset token is an attribute or data of the new block of the first blockchain, the first blockchain being limited from public access; and
providing the first blockchain as an input to a new block or a sidechain of a second blockchain, the second blockchain being publicly accessible and including the carbon offset token as a result of providing the first blockchain as an input to the new block or sidechain of the second blockchain;
wherein the steps of obtaining the time series data, determining the corresponding carbon emissions reduction, creating the carbon offset token, validating the new block, and providing the first blockchain as the input are implemented cooperatively by a plurality of devices.

9. The method of claim 8, wherein the corresponding carbon emissions reduction is either (i) measured based on data from a metering device and utility data, or (ii) estimated based on equipment data of the building equipment, space data of a space of the building, and a model of the building equipment.

10. The method of claim 8, wherein the green energy generation for the building comprises any of BioEnergy, GeoThermal energy, solar photovoltaic energy, hydropower energy, ocean energy, or wind energy.

11. The method of claim 8, wherein new blocks of the first blockchain are validated by a plurality of validators of the building, the plurality of validators being a plurality of different networked devices of the BAS.

12. The method of claim 8, wherein the new block of the first blockchain are validated using a proof of work or a proof of stake consensus algorithm.

13. The method of claim 8, wherein the carbon offset token comprises a plurality of attributes including:
an indication of an offset type of the corresponding carbon emissions reduction;
an indication of the threshold of the corresponding carbon emissions reduction;
a date and time that the carbon offset token is created;
whether the carbon offset token is created based on meter data or estimated data;
one or more addresses of validators of the carbon offset token; and
the time series data used to create the carbon offset token.

14. The method of claim 8, wherein the carbon offset token is exchangeable on the second blockchain for a tax refund for an owner of the carbon offset token.

15. A method for incentivizing carbon emissions reduction of a building, the method comprising:
generating a carbon offset token based on equipment data, the carbon offset token representing a quantified amount of carbon emissions reduction resulting from a reduced amount of energy consumption or an amount of green energy generation for the building indicated by the equipment data;
validating a new block of a first blockchain, wherein the carbon offset token is an attribute or data of the new block of the first blockchain, the first blockchain being limited from public access; and
providing the first blockchain as an input to a new block or a sidechain of a second blockchain, the second blockchain being publicly accessible and including the carbon offset token as a result of providing the first blockchain as an input to the new block or sidechain of the second blockchain.

16. The method of claim 15, wherein the amount of carbon emissions reduction is either (i) measured based on data from a metering device and utility data, or (ii) estimated based on equipment data of the building equipment, space data of a space of the building, and a model of the building equipment.

17. The method of claim 15, wherein the green energy generation for the building comprises any of BioEnergy, GeoThermal energy, solar photovoltaic energy, hydropower energy, ocean energy, or wind energy.

18. The method of claim 15, wherein new blocks of the first blockchain are validated by a plurality of validators of the building, the plurality of validators being a plurality of different networked devices of the BAS.

19. The method of claim 15, wherein the carbon offset token comprises a plurality of attributes including:
an indication of an offset type of the carbon emissions reduction;
an indication of a threshold of the carbon emissions reduction used to generate the carbon offset token;
a date and time that the carbon offset token is created;
whether the carbon offset token is created based on meter data or estimated data;
one or more addresses of validators of the carbon offset token; and
the time series data used to create the carbon offset token.

20. The method of claim 15, wherein the carbon offset token is exchangeable on the second blockchain for a tax refund for an owner of the carbon offset token.
